(19) United States
(12) Patent Application Publication
(10) Pub. No.: US 2025/0206617 A1
(43) Pub. Date: Jun. 26, 2025

(54) GRAPHENE MATERIAL, THREE-DIMENSIONAL GRAPHENE/METAL COMPOSITE MATERIAL AS WELL AS PREPARATION METHOD AND USE

(71) Applicant: NINGBO INSTITUTE OF MATERIALS TECHNOLOGY AND ENGINEERING, CHINESE ACADEMY OF SCIENCES, Ningbo (CN)

(72) Inventors: Xiaoqing LIU, Ningbo (CN); Wenjie YU, Ningbo (CN); Weiwei ZHAO, Ningbo (CN); Guangmeng CHEN, Ningbo (CN)

(73) Assignee: NINGBO INSTITUTE OF MATERIALS TECHNOLOGY AND ENGINEERING, CHINESE ACADEMY OF SCIENCES, Ningbo (CN)

(21) Appl. No.: 18/850,582

(22) PCT Filed: Dec. 26, 2023
(86) PCT No.: PCT/CN2023/141817

§ 371 Date: Sep. 25, 2024

(30) Foreign Application Priority Data
Nov. 7, 2022 (CN) 202211385959.2
Dec. 18, 2023 (CN) 202311754687.3

(51) Int. Cl. C01B 32/184

(52) U.S. Cl. CPC C01B 32/184; C01P 2002/70; C01P 2004/03; C01P 2006/40

(57) ABSTRACT

A graphene material, a three-dimensional graphene/metal composite material, as well as a preparation method and use are provided. The preparation method of the graphene material includes: performing irradiation treatment on a benzoxazine compound using laser to prepare a benzoxazine compound-based graphene material. The present application also discloses a three-dimensional graphene/metal composite material as well as a preparation method and use thereof. The preparation method of the graphene material includes: performing laser treatment on a benzoxazine compound to prepare three-dimensional graphene; electroplating using a mixed system including acetate, an organic solvent and water as an electroplating solution and the three-dimensional graphene as a working electrode to prepare the three-dimensional graphene/metal composite material. According to the present application, the liquid benzoxazine compound is used as a carbon source to prepare the graphene material; meanwhile, the three-dimensional graphene prepared based on the liquid carbon source is electroplated in a composite solvent.

### CROSS REFERENCE TO THE RELATED APPLICATIONS

This application is the national phase entry of International Application No. PCT/CN2023/141817, filed on Dec. 26, 2023, which is based upon and claims priority to Chinese Patent Application No. 202211385959.2, filed on Nov. 7, 2022 and to Chinese Patent Application No. 202311754687.3, filed on Dec. 18, 2023, the entire contents of which are incorporated herein by reference.

### TECHNICAL FIELD

The present application belongs to the technical field of new materials, and relates to a graphene material, a three-dimensional graphene/metal composite material, as well as a preparation method and use, particularly to a benzoxazine compound-based graphene material as well as a preparation method and use thereof, and use of the graphene material for the three-dimensional graphene/metal composite material.

### BACKGROUND

Laser induced graphitization refers to a technology that a carbon-containing precursor material is converted into a graphene material by utilizing laser ablation. The obtained graphene material is often referred to as laser induced graphene (LIG), generally including three components such as a few layers of graphene, graphite and amorphous carbon. Under the irradiation of laser, the molecular bond of the precursor material is broken and recombined, wherein a majority of elements are recombined into gas products to be quickly released, while carbon elements are partially recombined into a graphite material and porous honeycomb-shaped LIG is finally formed. Compared with other preparation methods of graphene materials, such the method for one-step generation using laser has attached wide attentions from researchers in various countries all over the world due to its advantages such as short preparation period, low cost and suitability for roll to roll generation methods. After years of development, precursor materials for preparing LIG have been greatly expanded, which are mainly divided into two categories: synthetic polymers and natural polymers. The former includes high-performance thermosetting polymers such as polyimide, polyethersulfone and polybenzoxazine, while the latter is represented by a natural bamboo material. The natural polymers are often less commonly used due to their complex compositions and poor product performance reproducibility.

However, synthetic polymers or natural polymer materials, as precursors for preparing LIG, have two key drawbacks in practical applications: 1) due to the infusibility and insolubility of polymer materials, the generated LIG is tightly attached to the surface of the precursor material and is difficult to detach, thereby greatly limiting its application scenarios, for example, Nature communications, 2014, 5, 5714., ACS nano, 2018, 12, 2176-2183 and patent CN110482531A; 2) when precursor components are functionally modified, chemical grafting, vacuum impregnation or co-curing methods can only be used, which are time-consuming, energy-consuming, and low in doping efficiency, for example, ACS Appl. Nano Mater. 2018, 1, 5053-5061, patent CN113060721A, and patent CN113549207A. How to overcome the current defects in the prior art to achieve low-cost, efficient and flexible preparation is of great significance for further development and application of laser-induced graphene materials.

Graphene, as a highly concerned two-dimensional nano material, has excellent mechanical strength, electrical conductivity and thermal conductivity, and is widely used in various fields. Two-dimensional graphene is a basic component unit for other carbon materials. A 3D porous electrode formed by stacking the two-dimensional graphene has high porosity, which is beneficial for enlarging a contact area between a carbon structure and an electrolyte, enhancing double-layer capacitance and pseudo-capacitance effects, so as to promote charge transfer, and therefore the two-dimensional graphene is widely used in the fields of supercapacitors, electrochemical sensors, catalysis and the like. The common 3D graphene preparation method includes a self-assembly method, a template method, etc, and the prepared three-dimensional graphene structure generally depends on selection of a template or container, and therefore is complicated in preparation process and poor in conductivity.

Laser induced graphene is a three-dimensional porous graphene skeleton prepared by a laser induced one-step method based on resins such as polyimide and polybenzoxazine as precursors, which has good industrial prospects in the fields of catalytic electrodes, supercapacitors, adsorption and the like. However, this method can only be used for preparing multi-layer graphene, and the conductivity and catalytic activity of the material difficultly meet actual application requirements. To achieve its high-performance application, it is often compounded with metals and metal oxides. The even dispersion of metal in LIG can be achieved by a metal salt in-situ doping method, but the form and content of the metal are difficultly controlled. Through electrochemical deposition on the surface of LIG, a porous composite material having high conductivity can be obtained while well ensuring the porous structure of LIG. However, due to insufficient infiltration between an electroplating solution and LIG, the electroplating solution cannot completely infiltrate the surface of LIG when electroplating is performed in a common aqueous solution, leading to a fact that metal particles cannot enter the pore structure inside LIG. In addition, the metal particles deposited in the aqueous solution are large in size, which easily causes the blocking of the pore structure of LIG, thereby creating the influence on subsequent properties (Composites Communications 32 (2022) 101187).

### SUMMARY

The main objective of the present application is to provide a benzoxazine compound-based graphene material as well as a preparation method and use thereof, to overcome the defects in the prior art.

Another objective of the present application is to provide a three-dimensional graphene/metal composite material as well as a preparation method and use thereof.

In order to achieve the above objectives, the technical solution adopted by the present application is as follows:
The embodiment of the present application provides a preparation method of a benzoxazine compound-based graphene material, including: performing irradiation treatment on a benzoxazine compound using laser so that the benzoxazine compound is converted into the benzoxazine compound-based graphene material;
wherein the benzoxazine compound includes a benzoxazine monomer and/or a benzoxazine monomer derivative; the benzoxazine compound is a liquid material.

The embodiment of the present application also provides the benzoxazine compound-based graphene material prepared by the above preparation method.

The embodiment of the present application also provides a preparation method of a benzoxazine compound-based graphene hybrid material and/or graphene composite material, including:
mixing the above benzoxazine compound with a doping precursor to form a composition, then performing irradiation treatment on the composition using laser to prepare the benzoxazine compound-based graphene hybrid material and/or graphene composite material.

The embodiment of the present application also provides the benzoxazine compound-based graphene hybrid material and/or graphene composite material prepared by the above preparation method.

The embodiment of the present application also provides use of the above graphene material or the above graphene hybrid material and/or graphene composite material in the fields of energy storage, energy conversion, catalysis, sensing or electromagnetic shielding.

The embodiment of the present application also provides a preparation method of a three-dimensional graphene/metal composite material, including:
performing laser treatment on a benzoxazine compound to prepare three-dimensional graphene; wherein the benzoxazine compound is a liquid material;
and, electroplating using a mixed system including acetate, an organic solvent and water as an electroplating solution and the three-dimensional graphene as a working electrode at a current density of 0.1 mA/cm²−3 mA/cm² to prepare a three-dimensional graphene/metal composite material.

The embodiment of the present application also provides the three-dimensional graphene/metal composite material prepared by the above preparation method, the three-dimensional graphene/metal composite material includes three-dimensional graphene and nano-sized metal particles; and the metal particles are loaded onto the internal pores or external surfaces of three-dimensional graphene.

The embodiment of the present application also provides use of the above three-dimensional graphene/metal composite material in preparing electrochemical sensors or detecting glucose.

Compared with the prior art, the present application has the beneficial effects:
(1) in the present application, the liquid benzoxazine compound is used as a carbon source, the liquid has incomparable advantages over solid and gaseous monomers in the past, and does not require further high-temperature curing processes or complex molding processes, that is, the liquid benzoxazine compound can be directly converted into the graphene material using laser irradiation, and therefore the entire implementation process is simpler, lower in energy consumption, convenient to operate, easy to implement, low in cost, and suitable for large-scale industrial production.
(2) The benzoxazine compound used in the present application can be meltable and soluble and unconverted monomers can be removed through solvents, thereby allowing LIG to exist in a form of no substrate and to be further utilized. Alternatively, the benzoxazine compound can be coated onto the target substrate material and then a corresponding LIG functional coating is generated in one step through laser irradiation. The flexibility in designing the form of LIG further expands the application range of LIG and has broad development and application prospects.
(3) The benzoxazine compound provided in the present application can be directly and uniformly mixed with a dopant in a molten state (a liquid state). Compared with the traditional precursor modification methods such as impregnation, chemical grafting and co-curing, the benzoxazine compound provided in the present application can be compatible with more types of dopants and corresponding doping amounts.
(4) In the present application, three-dimensional graphene is obtained based on a liquid benzoxazine compound. The solvent used in the electroplating solution is an organic solvent/water composite solvent, which overcomes the shortcomings of the pure organic solvent in the past and greatly enhances the conductivity of the solution, thereby improving the electroplating efficiency and avoiding the problem of long electroplating time in pure organic solution electroplating; in addition, the combination of the organic solvent and water reduces the surface energy of the solution, and enhances the infiltration between the electroplating solution and the three-dimensional graphene, thus allowing the metal nanoparticles to be uniformly loaded onto the surface of the three-dimensional graphene.
(5) In the present application, nano-sized metal particles are uniformly loaded onto the surface of graphene based on the three-dimensional graphene as a conductive skeleton by controlling the concentration and current density of the electroplating solution, thereby creating almost no effect on the structural integrity, porosity and material density of the three-dimensional structure while enhancing the conductivity and catalytic activity of the material.

### BRIEF DESCRIPTION OF THE DRAWINGS

In order to provide a clearer explanation of the embodiments or technical solutions in the present application or existing technology, a brief introduction will be given to the drawings required for the embodiments or existing technology description. It is obvious that the drawings described below are only some of the embodiments recorded in the present application. For those skilled in the art, other drawings can be obtained based on these drawings without creative labor.

FIG. 1 is a nuclear magnetic spectrogram of a benzoxazine monomer in example 1 of the present disclosure.

FIG. 2 is a demonstration image showing a benzoxazine monomer that is subjected to laser irradiation to generate a graphene material in example 1 of the present disclosure.

FIG. 3 is a digital picture of a patterned graphene material with a PET film surface prepared in example 1 of the present disclosure.

FIG. 4 is a scanning electron microscopy image of a graphene material prepared in example 1 of the present disclosure.

FIG. 5 is a diagram showing a Raman spectrum of a graphene material prepared in example 1 of the present disclosure.

FIG. 6 is a transmission electron microscopy image of a graphene material prepared in example 1 of the present disclosure.

FIG. 7 is a digital picture of a graphene material with a patterned cotton cloth surface prepared in example 2 of the present disclosure.

FIG. 8 is a digital picture of an independent self-supporting graphene material film prepared in example 3 of the present disclosure

FIG. 9A-FIG. 9C are an SEM image, Raman spectrum data map and an x-ray photoelectron spectrum data map of an N-doped graphene hybrid material prepared in example 8 of the present disclosure.

FIG. 10 is an x-ray diffraction image of TiO₂ nanoparticle and TiC nanoparticle loaded graphene composite material prepared in example 9 of the present disclosure.

FIG. 11 is a diagram showing preparation of a three-dimensional graphene/metal composite material in a typical embodiment of the present disclosure.

FIG. 12A-FIG. 12B are SEM images of three-dimensional porous graphene prepared in example 13 of the present disclosure.

FIG. 13 is a Raman spectrogram of three-dimensional porous graphene prepared in example 13 of the present disclosure.

FIG. 14 is a diagram showing conductivity of an electroplating solution in example 13 of the present disclosure.

FIG. 15A-FIG. 15B are SEM images of a three-dimensional graphene/metal composite material prepared in example 13 of the present disclosure.

FIG. 16A-FIG. 16B are SEM images of a three-dimensional graphene/metal composite material prepared in example 15 of the present disclosure.

FIG. 17 is an XRD image of a three-dimensional graphene/metal composite material prepared in example 13 of the present disclosure.

FIG. 18 is a CV diagram when a three-dimensional graphene/metal composite material prepared in example 13 of the present disclosure catalytically oxidizes glucose.

FIG. 19 is a diagram showing electrochemical current changes with time when a three-dimensional graphene/metal composite material prepared in example 13 of the present disclosure catalytically oxidizes glucose.

FIG. 20 is an SEM image of a three-dimensional graphene/metal composite material prepared in comparative example 4 of the present disclosure.

FIG. 21 is an SEM image of a three-dimensional graphene/metal composite material prepared in comparative example 5 of the present disclosure.

FIG. 22 is an SEM image of a three-dimensional graphene/metal composite material prepared in comparative example 6 of the present disclosure.

FIG. 23A-FIG. 23B are SEM images of a three-dimensional graphene/metal composite material prepared in comparative example 7 of the present disclosure.

FIG. 24 is an SEM image of a three-dimensional graphene/metal composite material prepared in comparative example 8 of the present disclosure.

FIG. 25A-FIG. 25B are SEM images of a three-dimensional graphene/metal composite material prepared in comparative example 9 of the present disclosure.

FIG. 26A-FIG. 26B are SEM images of a three-dimensional graphene/metal composite material prepared in comparative example 10 of the present disclosure.

FIG. 27A-FIG. 27B are SEM images of a three-dimensional graphene/metal composite material prepared in comparative example 11 of the present disclosure.

### DETAILED DESCRIPTION OF THE EMBODIMENTS

In view of the defects in the prior art, the applicant of this case proposes the technical solution of the present application through long-term research and lots of practices. Next, the technical solution of the present application will be clearly and completely described. Obviously, the described embodiments are some embodiments of the present disclosure, but not all the embodiments. Based on the embodiments of the present application, other embodiments obtained by persons of ordinary skill in the art without creative efforts are all included within the scope of protection of the present application.

Specifically, as an aspect of the technical solution of the present application, an involved preparation method of a benzoxazine compound-based graphene material includes: performing irradiation treatment on a benzoxazine compound using laser so that the benzoxazine compound is converted into the benzoxazine compound-based graphene material;
wherein the benzoxazine compound includes a benzoxazine monomer and/or a benzoxazine monomer derivative.

Further, the benzoxazine compound is a meltable and soluble non-polymer molecule.

Further, the benzoxazine compound is a benzoxazine compound having high carbon formation.

In some preferred embodiments, the wavelength of laser is 10.6 μm-248 nm.

In some preferred embodiments, the graphene material includes a few layers of graphene.

Further, the layer number of the graphene material is 2-9 layers.

Further, the graphene material also includes a small amount of graphite and/or amorphous carbon.

In some preferred embodiments, the preparation method includes: reacting a mixed reaction system including a phenol source, an amine source, polyformaldehyde and/or formaldehyde for 4-8 h at 70-120° C. to prepare the benzoxazine monomer.

Further, the phenol source has a structure represented by formula (I):

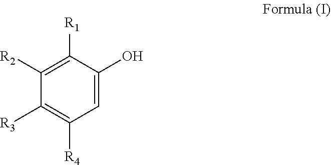

wherein R₁, R₂, R₃ and R₄ are all independently selected from any one of a hydrogen atom, hydroxyl, carboxyl, nitro, halogen, substituted or unsubstituted alkyl, alkene, an ester, alkoxy, phenyl and naphthyl.

Further, the amine source has a structure represented by formula (II):

H₂N—R₅ Formula (II)
wherein R₅ is selected from substituted or unsubstituted phenyl, furyl or naphthyl.

Further, a functional group molar ratio of the phenol source to the amine source to polyoxymethylene and/or formaldehyde is 1:0.5-2:1-5.

In some preferred embodiments, the preparation method includes: reacting any one of acyl halides, alcohols or halogenated alkanes with the benzoxazine monomer to prepare the benzoxazine monomer derivative.

Further, the acyl halide has a structure represented by formula (III):

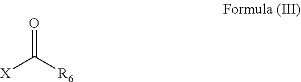

wherein X is selected from chloride, bromine or iodine, and R₆ is selected from substituted or unsubstituted alkyl, alkoxy, phenyl or naphthyl.

Further, the alcohol or halogenated alkane has a structure represented by formula (IV):

X—R₇ Formula (IV)
wherein X is selected from hydroxyl, chlorine, bromine or iodine, and R₇ is selected from substituted or unsubstituted alkyl, alkoxy, phenyl or naphthyl.

In some more specific embodiments, the preparation method of the benzoxazine compound-based graphene material (marked as an LIG material) includes: synthesizing a benzoxazine monomer through Mannich reaction by using a phenol source, an amine source, polyformaldehyde or formaldehyde and a solvent as raw materials, and then converting the benzoxazine monomer into a graphene material through laser irradiation.

In some more specific embodiments, the preparation method of the benzoxazine compound-based graphene material includes: synthesizing a benzoxazine monomer by using a phenol source, an amine source, polyformaldehyde or formaldehyde and a solvent as raw materials; then grafting target functional groups on a molecular structure of the benzoxazine monomer through a chemical grafting method to obtain a benzoxazine monomer derivative; and finally converting the obtained benzoxazine monomer derivative into an LIG material through laser irradiation.

Another aspect of the embodiment of the present application also provides the benzoxazine compound-based graphene material prepared by the above preparation method.

Another aspect of the embodiment of the present application also provides a preparation method of a benzoxazine compound-based graphene hybrid material (marked as an LIG hybrid material) and/or graphene composite material (marked as an LIG composite material), including:
mixing the above benzoxazine compound with a doping precursor to form a composition, then performing irradiation treatment on the composition using laser to prepare the benzoxazine compound-based graphene hybrid material and/or graphene composite material.

In some preferred embodiments, the doping precursor is a liquid and/or powder including any organic matter and/or inorganic matter.

Further, the doping precursor includes a combination of any one or more than two of metal nanoparticles, metal oxide nanoparticles, metal carbide nanoparticles, metal salts, metal organic compounds, MXene, graphene and its derivatives, carbon nanotubes, carbon fibers, carbon nanofibers, zeolite, nitrides, boric acids, boronic acid esters, phosphides, sulfides and fluorides, but is not limited thereto.

In some more specific embodiments, the preparation method of the benzoxazine compound-based graphene hybrid material includes: mixing the above benzoxazine compound with a liquid and/or powder of an organic matter containing at least one of N, P, S, B and F elements to form a composition, and then performing laser irradiation on the composition using laser to prepare the benzoxazine compound-based graphene hybrid material.

In some more specific embodiments, the preparation method of the benzoxazine compound-based graphene hybrid material includes: mixing the above benzoxazine compound with a liquid and/or powder of an inorganic matter and/or a metal organic compound to form a composition, and then performing laser irradiation on the composition using laser to prepare the graphene composite material based on the benzoxazine compound.

In some preferred embodiments, the wavelength of laser is 10.6 μm-248 nm.

In some preferred embodiments, the graphene hybrid material and/or graphene composite material includes a few layers of graphene.

Further, the graphene hybrid material and/or graphene composite material also includes a small amount of graphite and/or amorphous carbon.

Another aspect of the embodiment of the present application also provides the benzoxazine compound-based graphene hybrid material and/or graphene composite material prepared by the above preparation method.

In the present application, the special chemical structure of the benzoxazine compound can be directly converted to generate the LIG material through laser irradiation. After undergoing laser irradiation, the structure of the benzoxazine compound with high carbon formation generates local instant high temperature (>2000° C.), and the gasification and decomposition of the benzoxazine compound occur almost simultaneously in an instant. Where, C—C, C—N, C—O, C—H and other chemical bonds in the molecule structures of the most benzoxazine compounds are broken at a high temperature. A part of these elements is recombined to form a graphene structure, and the other part is recombined to be released in a form of gas product. On the one hand, the quick release of the gas product inhibits the accumulation of graphene lamella and leads to the feature of a final three-dimensional porous structure. On the other hand, a large amount of gas products dilute the concentration of oxygen in air, thereby protecting the generated graphene structure from being oxidized at a high temperature.

The uniqueness of the benzoxazine compound in the present application lies in its molecular structure with high carbon formation. The benzoxazine compound can be directly converted into the graphene material with no need of being polymerized into a large molecular polymer.

In the present application, the used benzoxazine monomer and/or its derivatives are meltable and soluble, allowing the prepared graphene material to be utilized in a form of a coating or a self-supporting film. In addition, the molten (liquid) benzoxazine monomer and/or its derivatives can also be uniformly mixed directly with a dopant. Compared with the traditional precursor modification methods such as impregnation, chemical grafting and co-curing, the molten (liquid) benzoxazine monomer and/or its derivatives can be compatible with more types of dopants and corresponding doping amounts. The preparation method of the benzoxazine monomer-based graphene material and/or its derivatives provided by the present application are simple in process, short in preparation period and low in cost, and have obvious advantages compared with the existing graphene material preparation technology. The functional forms (coating and films) and components of the prepared graphene material can be flexibly customized and regulated.

Another aspect of the embodiment of the present application also provides use of the above graphene material or graphene hybrid material and/or graphene composite material in the fields of energy storage, energy conversion, catalysis, sensing or electromagnetic shielding.

Another aspect of the embodiment of the present application also provides a preparation method of a three-dimensional graphene/metal composite material, including:
performing laser treatment on a benzoxazine compound to prepare three-dimensional graphene; wherein the benzoxazine compound is a liquid material;
and, electroplating using a mixed system including acetate, an organic solvent and water as an electroplating solution and the three-dimensional graphene as a working electrode at a current density of 0.1 mA/cm²−3 mA/cm² to prepare the three-dimensional graphene/metal composite material.

In some preferred embodiments, the benzoxazine compound includes a benzoxazine monomer and/or a benzoxazine monomer derivative, i.e., the above benzoxazine compound.

Further, the benzoxazine compound is a meltable and soluble non-polymer molecule.

Further, the benzoxazine compound is a benzoxazine compound having high carbon formation.

In one preferred embodiments, the laser source used for laser treatment includes CO₂ laser, with a laser power of 2.5 W-15 W.

In some preferred embodiments, the scanning speed used for laser treatment is 6-40 cm/s, and the Z-axis defocus distance is 0-7 mm.

In some preferred embodiments, the three-dimensional graphene has a porous structure, and the pore size of the pores contained in the three-dimensional graphene is 5-20 μm.

In some preferred embodiments, the preparation method specifically includes: performing laser patterning treatment on the benzoxazine compound using laser to prepare patterned three-dimensional graphene.

Further, the patterns contained in the patterned three-dimensional graphene include an electrode structure having a combination of any one or more than two of a straight line, a curve, a polygon, a circle, a ring and a sector.

In some preferred embodiments, the preparation method specifically includes: evenly mixing an organic solvent with water at a room temperature and then adding acetate and performing ultrasonic dissolution, and then separating supernatant as an electroplating solution by standing.

In some preferred embodiments, the organic solvent includes a combination of any one or more than two of ethanol, acetonitrile and acetone, but is not limited thereto.

In some preferred embodiments, the water is deionized water, but is not limited thereto.

In some preferred embodiments, the acetate includes a combination of any one or more than two of copper acetate (such as anhydrous copper acetate and copper acetate monohydrate), nickel acetate, iron acetate and cobalt acetate, but is not limited thereto.

In some preferred embodiments, a volume ratio of the organic solvent to the water in the electroplating solution is 1:0.2-1:4.

Further, the volume ratio of the organic solvent to the water in the electroplating solution is 1:0.2-1:1.

In some preferred embodiments, the concentration of acetate in the electroplating solution is 0.05 g/100 mL-1 g/100 mL.

Further, the concentration of acetate in the electroplating solution is 0.05 g/100 mL-0.5 g/100 mL.

In some preferred embodiments, the current density is 0.2 mA/cm²−2 mA/cm².

In some preferred embodiments, the preparation method specifically includes: electroplating in the electroplating solution by using the three-dimensional graphene as a working electrode, a Cu slice or graphite electrode as an auxiliary electrode and an Ag/AgCl electrode as a reference electrode to prepare a three-dimensional graphene/metal composite material; wherein the area of the auxiliary electrode is more than 3 times that of the working electrode.

In some preferred embodiments, the preparation method also includes: washing and drying the obtained product after the electroplating is completed.

Further, washing is performed using acetonitrile and water.

In some more specific embodiments, the preparation method of the three-dimensional graphene/metal composite material includes the following steps:
(1) performing laser treatment on a benzoxazine compound to obtain a three-dimensional graphene conductive skeleton (namely, the above three-dimensional graphene, marked as LIG), wherein the laser source used for laser treatment is CO₂ laser, the laser power is 2.5 W-10 W, the scanning speed is 6-30 cm/s, and the Z-axis defocus distance is 0-7 mm;
(2) preparing an electroplating solution, wherein the solvent uses a mixed solution of an organic solvent and water, the volume ratio of the organic solvent to the water is 1:0-1:1, then acetate is added into the above mixed solvent, the concentration of acetate is 0.05 g/100 mL-0.5 g/100 mL, and then performing ultrasonic treatment for 5 min at a room temperature until acetate is completely dissolved. The above electroplating solution is subjected to standing for 2-5 days at the room temperature, and supernatant is taken as a final electroplating solution.
(3) When electroplating, LIG is used as a working electrode, a Cu slice or a graphite electrode is used as an auxiliary electrode, and an Ag/AgCl electrode is used as a reference electrode. Where, the area of the auxiliary electrode is required to be more than 3 times that of the working electrode. The current density of electroplating is 0.2 mA/cm²-2 mA/cm², and the electroplating time is 0.5 h-3 h.
(4) The electroplated LIG is rinsed with a large amount of acetonitrile and water respectively, and then dried for 1 h in a vacuum oven at 60° C. to obtain a three-dimensional graphene/metal composite material.

Preferably, patterning treatment is performed on the benzoxazine compound by using laser to obtain patterned three-dimensional graphene with a conductive network, wherein the patterns contained in the patterned graphene include a combination of any one or more than two of electrode structures having a straight line, a curve, a polygon, a circle, a ring and a sector.

Preferably, the organic solvent is a combination of any one or more than two of ethanol, acetonitrile and acetone.

Preferably, the acetate is a combination of any one or more than two of copper acetate, nickel acetate, iron acetate and cobalt acetate.

In the present application, the solution used in the process of electroplating is an acetate solution, and the used solvent is an organic solvent/water composite solvent, so as to significantly enhance the conductivity of the solution, thereby improving the electroplating efficiency, avoiding the problem of long electroplating time when electroplating is performed in a pure organic solution. In addition, the combination of the organic solvent and the water reduces the surface energy of the solution and enhances the infiltration between the electroplating solution and LIG, thereby enabling metal nanoparticles to be evenly loaded onto the surface of LIG with almost no influences on the porous structure inside LIG. The finally obtained composite material retains the porous structure of LIG, has good conductivity, and therefore is expected to exert an important effect in the fields of electrochemical sensors, catalysis, supercapacitors and the like.

Another aspect of the embodiment of the present application also provides the three-dimensional graphene/metal composite material prepared by the above preparation method. The three-dimensional graphene/metal composite material includes three-dimensional graphene and nano-sized metal particles; the metal particles are loaded onto the internal pores or external surface of the three-dimensional graphene.

Further, the particle size of the metal particle is 100-500 nm.

Further, the content of metal particles in three-dimensional graphene/metal composite material is 10-70 wt %.

Another aspect of the embodiment of the present application also provides use of the above three-dimensional graphene/metal composite material in preparing electrochemical sensors or detecting glucose.

Next, the technical solution of the present application will be further described in detail in combination with several preferred embodiments. The embodiments are implemented on the premise of the technical solution of the present application to give detailed embodiments and specific operation processes, but the scope of protection of the present application is not limited to the following examples.

The testing methods for the electrochemical catalytic performance of the composite material in the following examples are as follows:

CV (cyclic voltammetry) curve testing: electrochemical catalytic performance testing is performed in a 1 M KOH solution, the concentration of glucose is 1 mM, an area of a working electrode (LIG-Cu) is 1.5×1 cm², a counter electrode is a graphite electrode (2×2 cm²), and a reference electrode is an Ag/AgCl electrode. The voltage scanning range is 0-0.8 V, and the scanning rate is 40 mV/s.

Timing current response testing: the testing is performed in a 1 M KOH solution, and stirring is carried out using a magnetic stirrer. During the testing, the potential is controlled as 0.5 V, and timing is started after the current is stable. A certain concentration of glucose aqueous solution is added into the electroplating solution at a fixed time point using a pipette for detecting current change. The rest testing conditions are the same as those of CV.

Experimental materials used in the following examples, unless specified otherwise, are all purchased from conventional biochemical reagent companies.

### Example 1

(1) 1.0 mol of propyl gallate, 2.0 mol of furfuryl amine and 5.0 mol of paraformaldehyde reacted for 5 h at 80° C. based on dioxane as a solvent to obtain a faint yellow transparent solution. A saturated sodium carbonate solution and water were successively used to remove unreacted raw materials. Finally, the solvent was removed by using a rotary evaporator to obtain a benzoxazine monomer product. FIG. 1 is a nuclear magnetic resonance image of the obtained benzoxazine monomer, specifically: 1H NMR (400 MHZ, Chloroform-d) δ 7.40 (dd, J=1.9, 0.8 Hz, 2H), 6.32 (dd, J=3.2, 1.9 Hz, 2H), 6.24 (dd, J=3.1, 0.8 Hz, 2H), 4.96 (s, 4H), 4.16 (t, J=6.7 Hz, 2H), 4.13 (s, 4H), 3.89 (s, 4H), 1.68 (q, J=7.1 Hz, 2H), 0.94 (t, J=7.4 Hz, 3H).

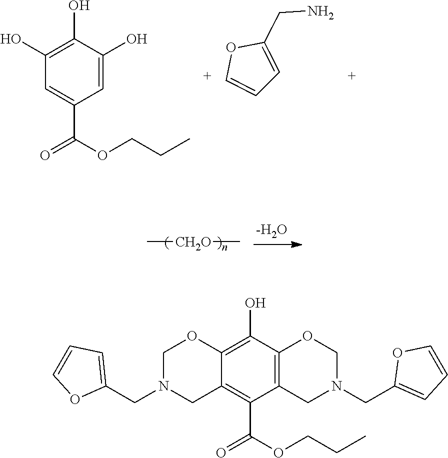

(2) The obtained benzoxazine monomer was coated onto a polyethylene terephthalate (PET) film, subjected to laser irradiation using a CO₂ infrared laser device with a wavelength of 10.6 μm, and the irradiation route of laser was programmable. Under the photothermal action of laser, the benzoxazine monomer was directly converted into a graphene material.
(3) The unconverted benzoxazine monomer was washed away with acetone to obtain a graphene material layer attached to the PET film.

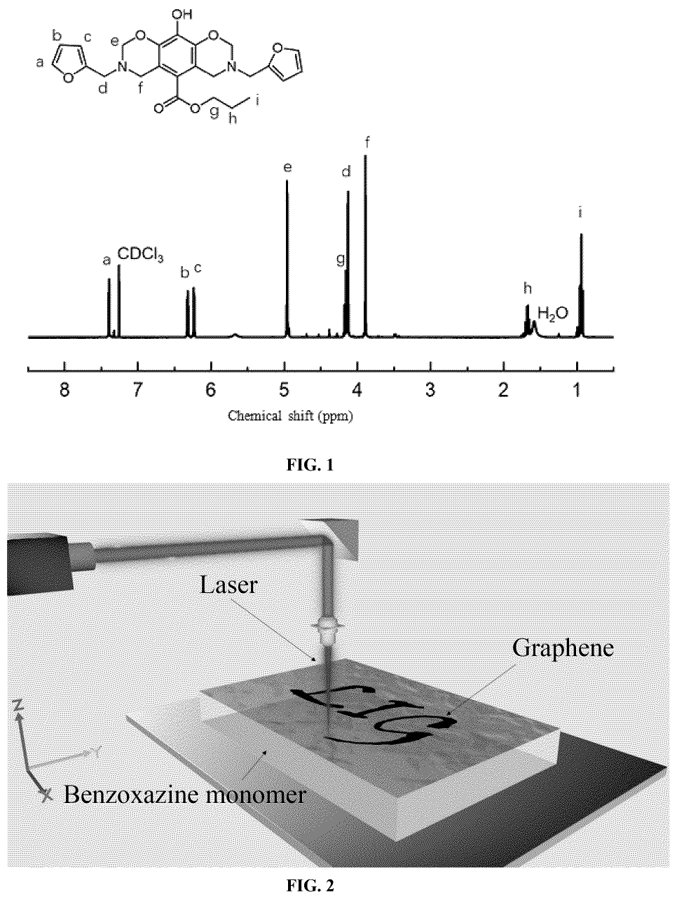

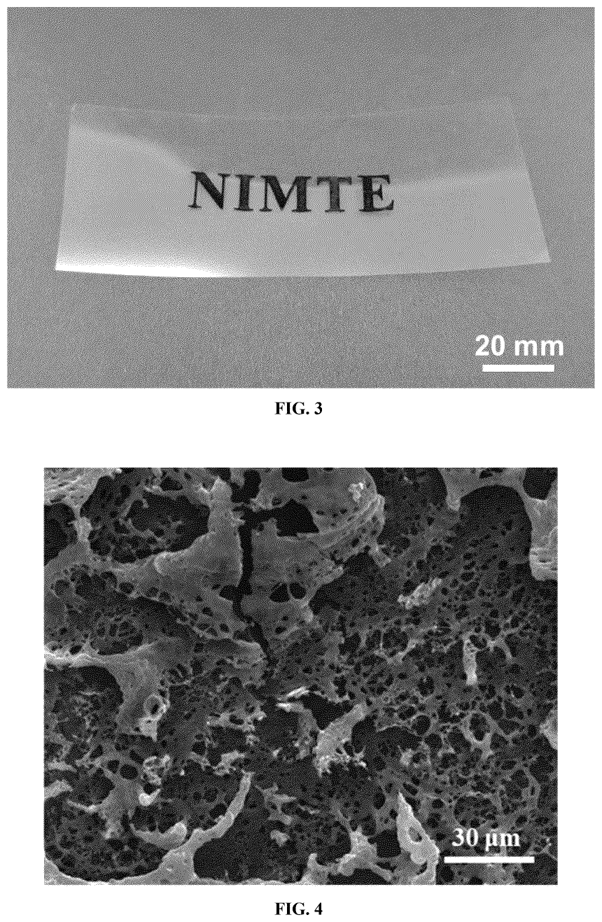

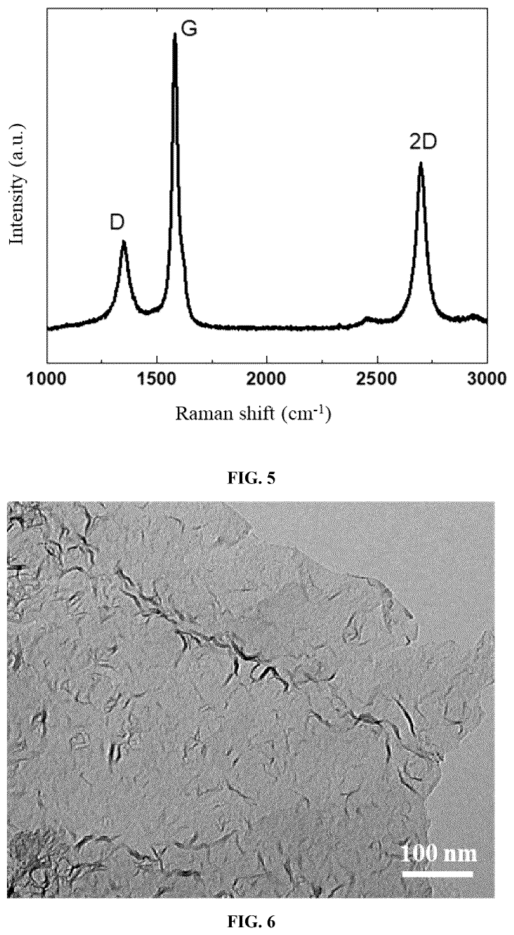

FIG. 2 is a demonstration diagram showing laser irradiation of a benzoxazine monomer; the inventor of this case analyzed the graphene material prepared in this example. FIG. 3 is a digital picture of a patterned graphene material on the surface of a PET film. FIG. 4 is a scanning electron microscopy image of a graphene material, from which a three-dimensional porous structure can be observed due to rapid release of a gas product caused by laser irradiation. The Raman spectrum of the graphene material is as shown in FIG. 5, showing three outstanding characteristic peaks: D peak at about 1350 cm⁻¹ is a disordered vibration peak caused by drawbacks or bending of sp2 carbon, and the intensity of the D peak is only related to the disordered degree of graphene; G peak at about 1580 cm⁻¹ is caused by in-plane vibration of carbon atoms, an intensity ratio of D peak to G peak is generally used as an important parameter characterizing graphene defect concentration; 2D peak at 2700 cm⁻¹ is a second-order mode of the D peak of graphene, the higher defect concentration of the graphene can cause the stronger D peak intensity while reducing the intensity of the 2D peak. For high-quality graphene, the D peak is absent, however, the 2D peak does not disappear. Under the transmission electron microscope, as shown in FIG. 6, the nano structure of a few layers of graphene can be observed.

### Example 2

(1) 1.0 mol of pyrocatechol, 2.0 mol of aniline and 5.0 mol of paraformaldehyde reacted for 5 h at 80° C. based on dioxane as a solvent to obtain a yellow transparent solution. A saturated sodium carbonate solution and water were successively used to remove unreacted raw materials. Finally, the solvent was removed by using a rotary evaporator to obtain a benzoxazine monomer product.

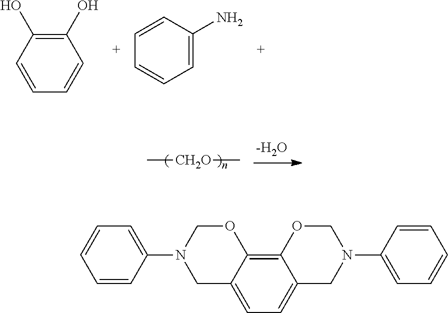

(2) The obtained benzoxazine monomer was coated onto cotton cloth, subjected to laser irradiation using a CO₂ infrared laser device with a wavelength of 9.3 μm, and the irradiation route of laser was programmable. Under the photothermal action of laser, the benzoxazine monomer was directly converted into a graphene material.
(3) The unconverted benzoxazine monomer was washed away with acetone to obtain a graphene material attached to the cotton cloth.

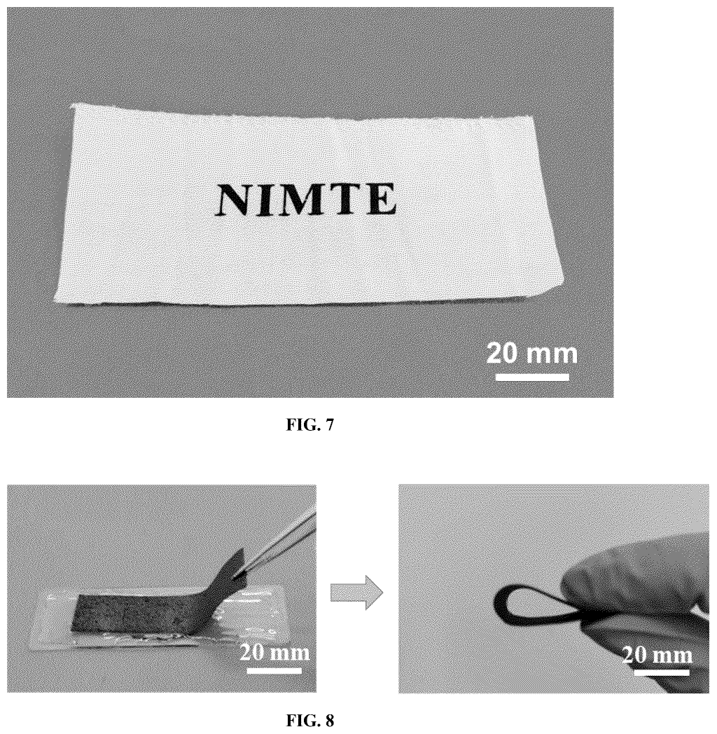

FIG. 7 is a digital picture of a graphene material attached to cotton cloth.

### Example 3

(1) 1.0 mol of o-phenylphenol, 1.0 mol of aniline and 3.0 mol of paraformaldehyde reacted for 5 h at 120° C. based on dioxane as a solvent to obtain a yellow transparent solution. A saturated sodium carbonate solution and water were successively used to remove unreacted raw materials. Finally, the solvent was removed by using a rotary evaporator to obtain a benzoxazine monomer product.

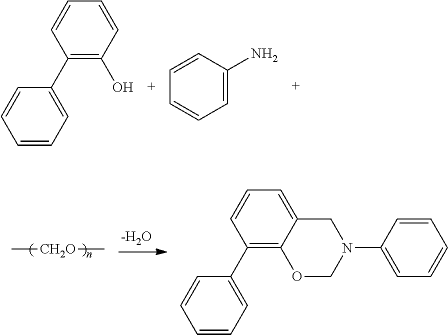

(2) The obtained benzoxazine monomer was coated onto glass and then subjected to laser irradiation using a laser device with a wavelength of 532 nano, and the irradiation route of laser was programmable. Under the photothermal action of laser, the benzoxazine monomer was directly converted into a graphene material.
(3) The unconverted benzoxazine monomer was washed away with acetone to obtain an independent self-supporting graphene material.

FIG. 8 is a digital picture of an independent self-supporting three-dimensional porous graphene film material.

### Example 4

(1) 1.0 mol of pyrogallol, 2.0 mol of aniline and 5.0 mol of paraformaldehyde reacted for 5 h at 70° C. based on ethyl acetate as a solvent and then cooled to room temperature, so as to separate out a large amount of white powders. The white powders were washed with hot ethanol, filtered and dried, so as to finally obtain a faint yellow powder product.

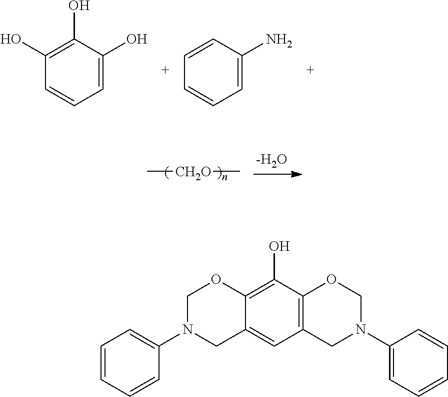

(2) The obtained benzoxazine monomer was coated onto glass and then subjected to laser irradiation using a laser device with a wavelength of 450 nm, and the irradiation route of laser was programmable. Under the photothermal action of laser, the benzoxazine monomer was directly converted into a graphene material.
(3) The unconverted benzoxazine monomer was washed away with acetone to obtain an independent self-supporting graphene material film.

### Example 5

(1) 1.0 mol of pyrogallol, 2.0 mol of aniline and 5.0 mol of paraformaldehyde reacted for 5 h at 70° C. based on ethyl acetate as a solvent and then cooled to room temperature, so as to separate out a large amount of white powders. The white powders were washed with ethanol, filtered and dried, so as to finally obtain a white product.

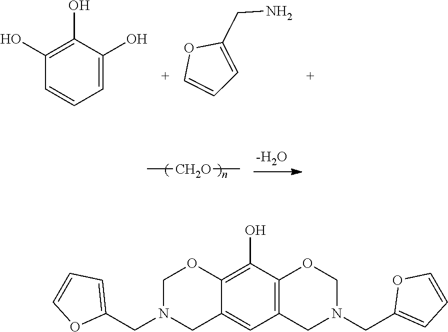

(2) The obtained benzoxazine monomer was coated onto cotton cloth and then subjected to laser irradiation using a laser device with a wavelength of 800 nm, and the irradiation route of laser was programmable. Under the photothermal action of laser, the benzoxazine monomer was directly converted into a graphene material.
(3) The unconverted benzoxazine monomer was washed away with acetone to obtain a graphene material attached to the cotton cloth.
(4) The obtained three-dimensional graphene material is used to fabricate a planar supercapacitor with a specific capacitance of 5 mFcm⁻² and a power density of about 10 mWcm⁻².

### Example 6

(1) 1.0 mol of benzoxazine monomer prepared in example 4 was dissolved into chloroform, and 1.2 mol of triethylamine was added as an acid binding agent. 1.2 mol of nonanoyl chloride was slowly dropwise added into the above solution, and then the above solution reacted for 6 h in an ice water bath.
(2) The above solution after the completion of the reaction was washed with 1.0 mol of hydrochloric acid aqueous solution and deionized water, respectively. The solvent was removed by using a rotary evaporator to obtain a yellow transparent nonanoyl chloride modified benzoxazine monomer.

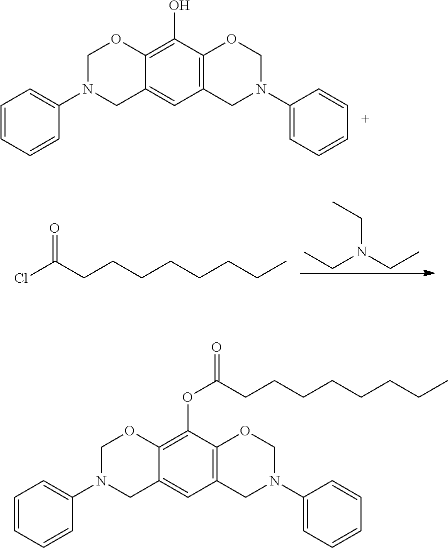

(3) The obtained benzoxazine monomer was coated onto a silicon wafer and subjected to laser irradiation using a laser device with a wavelength of 788 nm, and the irradiation route of laser was programmable. Under the photothermal action of laser, the benzoxazine monomer derivative was directly converted into a graphene material.
(4) The unconverted benzoxazine monomer was washed away with acetone to obtain an independent self-supporting graphene material.

### Example 7

(1) 1.0 mol of benzoxazine monomer prepared in example 5 was dissolved into chloroform, and 1.2 mol of sodium carbonate was added. 3.0 mol of bromopentane was slowly dropwise added into the above solution, and then the above solution reacted for 6 h.
(2) The above solution after the completion of the reaction was washed with 1.0 mol of hydrochloric acid aqueous solution and deionzied water, respectively. The solvent was removed by using a rotary evaporator to obtain a yellow transparent nonanoyl chloride modified benzoxazine monomer.

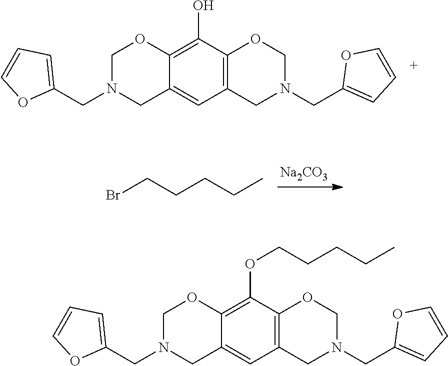

(3) The obtained benzoxazine monomer was coated onto a silicon wafer and subjected to laser irradiation using a laser device with a wavelength of 10.6 μm, and the irradiation route of laser was programmable. Under the photothermal action of laser, the benzoxazine monomer derivative was directly converted into a graphene material.
(4) The unconverted benzoxazine monomer was washed away with acetone to obtain an independent self-supporting graphene material film.

### Example 8

(1) The benzoxazine monomer derivative in example 6 and urea were evenly blended in a mass ratio of 10:1, and then sufficiently and evenly stirred at 70° C. to obtain a urea/benzoxazine monomer derivative composition.

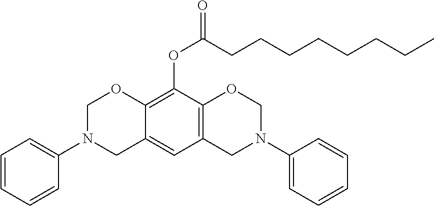 [SMILES: CCCCCCCCC(=O)Oc1c2c(cc3c1OCN(c1ccccc1)C3)CN(c1ccccc1)CO2]

(2) The obtained urea/benzoxazine monomer derivative composition was coated onto a silicon wafer and then subjected to laser irradiation using a CO₂ infrared laser device with a wavelength of 10.6 μm. Under the photothermal action of laser, the composition was directly converted into an N-doped graphene hybrid material.
(3) The unconverted benzoxazine monomer was washed away with acetone to obtain an independent self-supporting N-doped graphene hybrid material film.

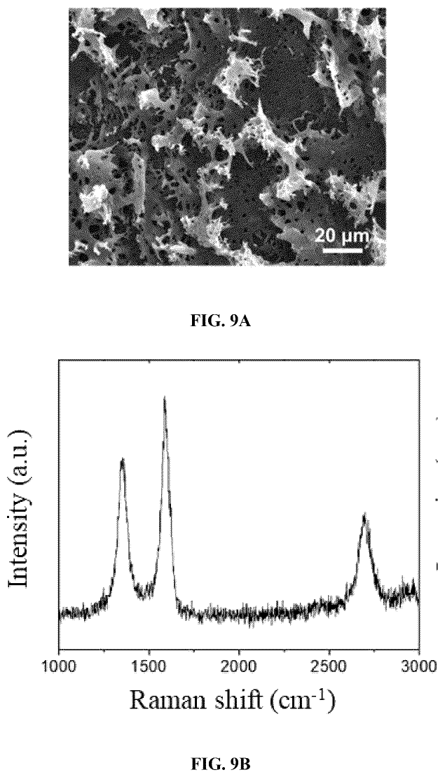

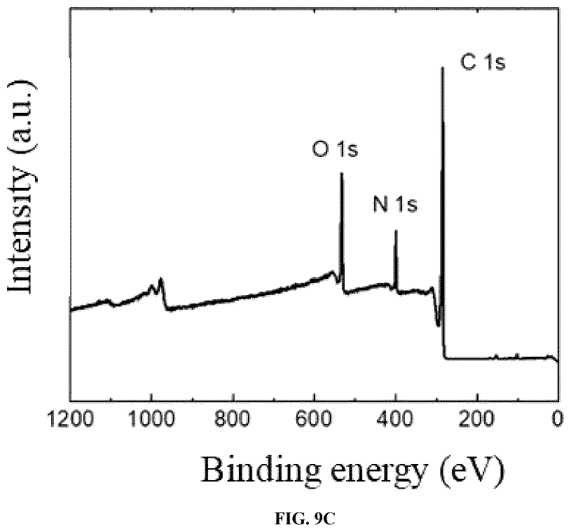

FIG. 9A-FIG. 9C are an SEM image, a Raman spectrum data map and an x-ray photoelectron spectrum data map of the obtained N-doped graphene hybrid material. The results of the x-ray photoelectron spectrum show that the content of N in the N-doped graphene hybrid material is 7.8 at %.

### Example 9

(1) The benzoxazine monomer derivative in example 6 and TiO₂ nanoparticles were evenly blended in a mass ratio of 10:1, and then sufficiently and evenly stirred at 70° C. to obtain a TiO₂ nanoparticle/benzoxazine monomer derivative composition.

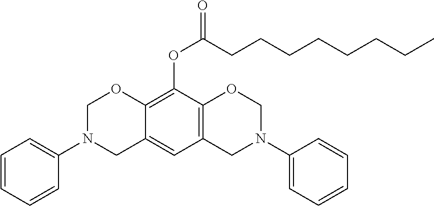 [SMILES: CCCCCCCCC(=O)Oc1c2c(cc3c1OCN(c1ccccc1)C3)CN(c1ccccc1)CO2]

(2) The obtained TiO₂ nanoparticle/benzoxazine monomer derivative composition was coated onto a silicon wafer and then subjected to laser irradiation using a laser device with a wavelength of 248 nm. Under the photothermal action of laser, the composition was directly converted into a TiO₂ nanoparticle and TiC nanoparticle (a part of TiO₂ nanoparticles and a carbon material reacted in a high temperature in this example) loaded graphene composite material.
(3) The unconverted benzoxazine monomer was washed away with acetone to obtain an independent self-supporting TiO₂ nanoparticle and TiC nanoparticle loaded graphene composite material film.

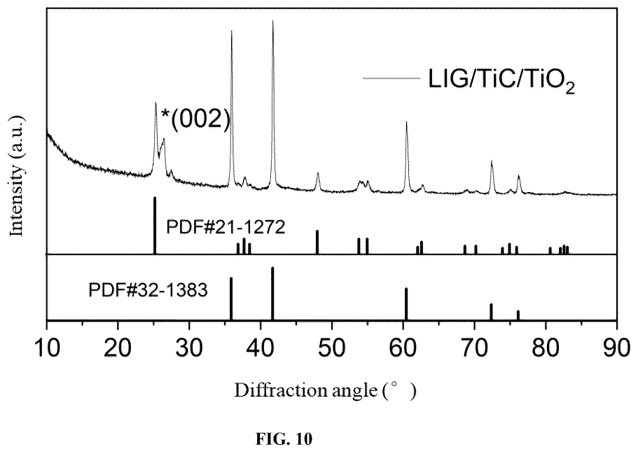

FIG. 10 is an x-ray diffraction image of a TiO₂ nanoparticle and TiC nanoparticle loaded graphene material.

### Example 10

(1) The benzoxazine monomer derivative in example 6 and ferric acetylacetonate were evenly blended in a mass ratio of 10:3, and sufficiently and evenly stirred at 70° C. to obtain a ferric acetylacetonate/benzoxazine monomer derivative composition.

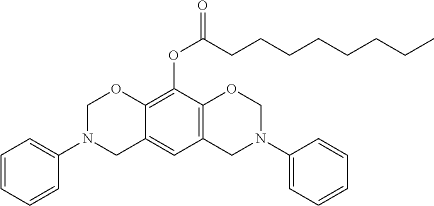 [SMILES: CCCCCCCCC(=O)Oc1c2c(cc3c1OCN(c1ccccc1)C3)CN(c1ccccc1)CO2]

(2) The obtained ferric acetylacetonate/benzoxazine monomer derivative composition was coated onto a silicon wafer and then subjected to laser irradiation using an infrared laser device with a wavelength of 9.3 μm. Under the photothermal action of laser, the composition was directly converted into an iron nanoparticle loaded graphene composite material.
(3) The unconverted benzoxazine monomer was washed away with acetone to obtain an independent self-supporting iron nanoparticle loaded graphene composite material film.
(4) The prepared iron nanoparticle loaded graphene composite material was used as an electromagnetic shielding film having an electromagnetic shielding efficiency of 24.8 dB.

### Example 11

(1) The benzoxazine monomer derivative in example 7 and zinc acetylacetonate were evenly blended in a mass ratio of 10:3, and sufficiently and evenly stirred at 70° C. to obtain a zinc acetylacetonate/benzoxazine monomer derivative composition.

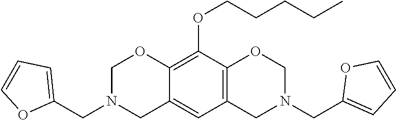 [SMILES: CCCCCOc1c2c(cc3c1OCN(Cc1ccco1)C3)CN(Cc1ccco1)CO2]

(2) The obtained composition was coated onto a silicon wafer and then subjected to laser irradiation using a laser device with a wavelength of 9.3 μm. Under the photothermal action of laser, the composition was directly converted into Zn nanoparticle and ZnO nanoparticle loaded graphene composite material.
(3) The unconverted benzoxazine monomer was washed away with acetone to obtain an independent self-supporting Zn nanoparticle and ZnO nanoparticle loaded graphene composite

### Example 12

(1) The benzoxazine monomer derivative in example 7 and carbon fiber felt were evenly blended in a mass ratio of 1:1, and subjected to bubble extraction for 30 min in a vacuum oven at 90° C. so that the benzoxazine monomer was sufficiently immersed into the carbon fiber felt to obtain a carbon fiber felt/benzoxazine monomer derivative composition.

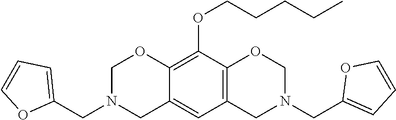 [SMILES: CCCCCOc1c2c(cc3c1OCN(Cc1ccco1)C3)CN(Cc1ccco1)CO2]

(2) The carbon fiber felt/benzoxazine monomer derivative composition was exposed to the irradiation of laser with a wavelength of 9.3 μm. Under the photothermal action of laser, the directly converted into a graphene/carbon fiber composite material.
(3) The unconverted benzoxazine monomer was washed away with acetone.

### Comparative Example 1

(1) A proper amount of benzoxazine monomer in example 4 was placed in a 10*10 cm silicone mold.
(2) The benzoxazine monomer was cured for 2 h in ovens at 180° C. and 220° C. in turn to obtain a polybenzoxazine resin.
(3) The obtained resin slice was irradiated by using 10.6 μm CO₂ infrared laser to obtain a converted graphene lamina on the surface of the resin.
(4) Since the polymer material was not meltable and soluble, the obtained graphene material cannot be separated from a resin matrix, and therefore can only scraped out in a form of powder, but cannot be present in a form of independent self-supporting graphene film.

### Comparative Example 2

(1) The benzoxazine monomer derivative in example 6 and ferric acetylacetonate were evenly blended in a mass ratio of 10:3, and sufficiently and evenly stirred at 70° C. to obtain a ferric acetylacetonate/benzoxazine monomer derivative composition.
(2) The obtained composition was placed in a 10*10 cm silicone mold, and cured for 2 h in ovens at 180° C. and 220° C. in turn to obtain a ferric acetylacetonate/benzoxazine resin slice.
(3) The obtained resin slice was irradiated by using 10.6 μm CO₂ infrared laser to obtain an iron nanoparticle loaded graphene composite material lamina (with a thickness of 35 μm) converted on the surface of the resin.
(4) Since the polymer was not meltable and soluble, the obtained iron nanoparticle loaded graphene composite material can only be attached to the surface of a polyresin, and cannot be applied in a form of independent self-supporting graphene film. The resin slice loaded with the graphene composite material was subjected to electromagnetic efficiency testing, only with the electromagnetic efficiency of 15.2 dB.

### Comparative Example 3

(1) The benzoxazine monomer derivative in example 6 and urea were evenly blended in a mass ratio of 10:1, and sufficiently and evenly stirred at 70° C. to obtain a urea/benzoxazine monomer derivative composition.
(2) The obtained composition was placed in a 10*10 cm silicone mold, and cured for 2 h in ovens at 150° C. and 180° C. in turn to obtain a urea/benzoxazine resin slice.
(3) The benzoxazine monomer was separated from urea in the process of cross linking and curing so that a large amount of urea particles were separated out from the benzoxazine resin.
(4) The urea/benzoxazine resin slice was subjected to laser irradiation using a CO₂ infrared laser device with a wavelength of 10.6 μm. Under the photothermal action of laser, the resin slice was directly converted into an N-doped graphene hybrid material.
(5) The obtained N-doped graphene hybrid material was characterized by using X-ray electron spectrum, and the results show that the doping content of Nis 4.8 at %.

### Example 13

### Preparation of Benzoxazine Compound

1.0 mol of propyl gallate, 2.0 mol of furfuryl amine and 5.0 mol of paraformaldehyde reacted for 5 h at 80° C. based on dioxane as a solvent to obtain a faint yellow transparent solution. A saturated sodium carbonate solution and water were successively used to remove unreacted raw materials. Finally, the solvent was removed by using a rotary evaporator to obtain a benzoxazine monomer product.

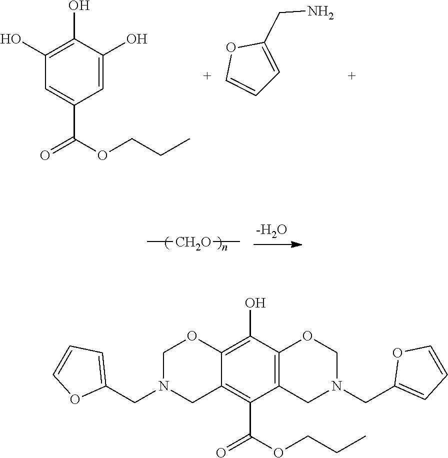

### Preparation of Three-Dimensional Graphene/Metal Composite Material:

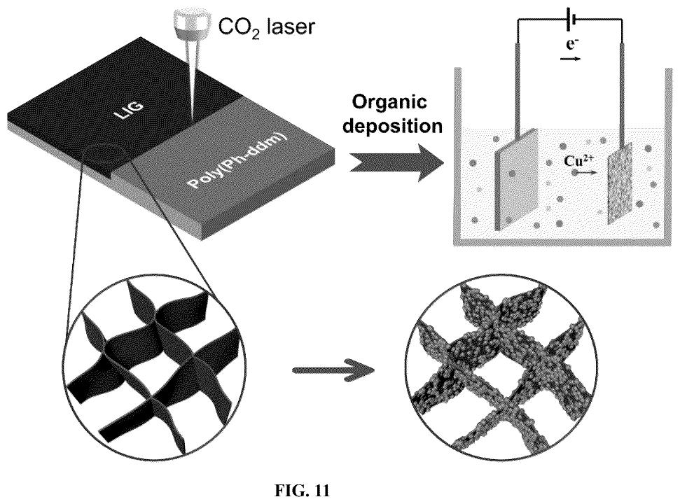

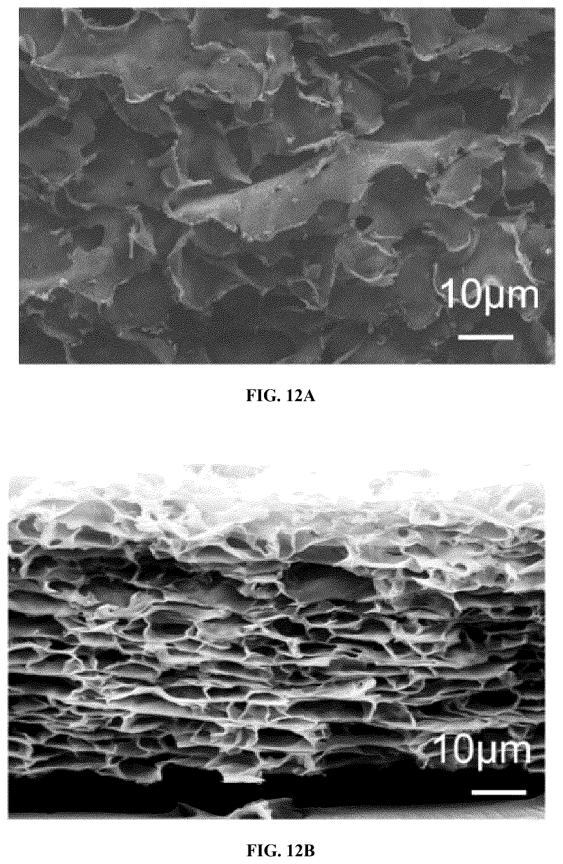

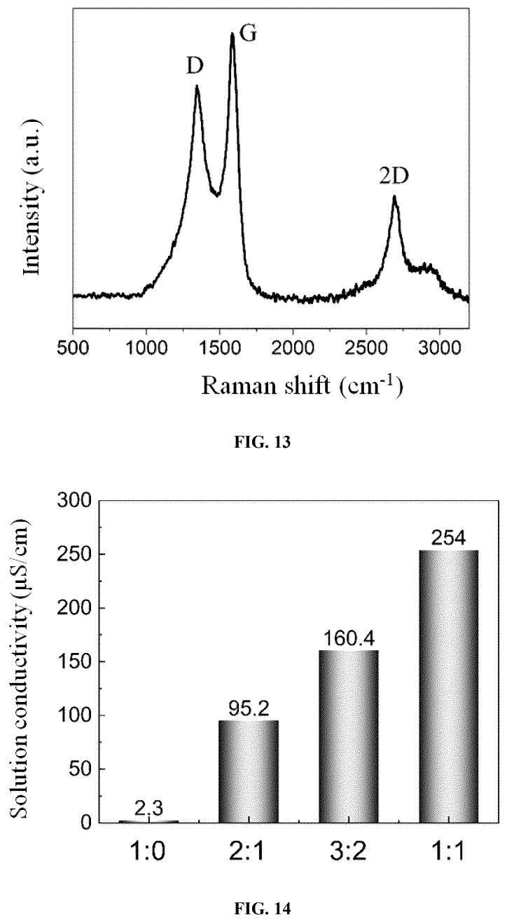

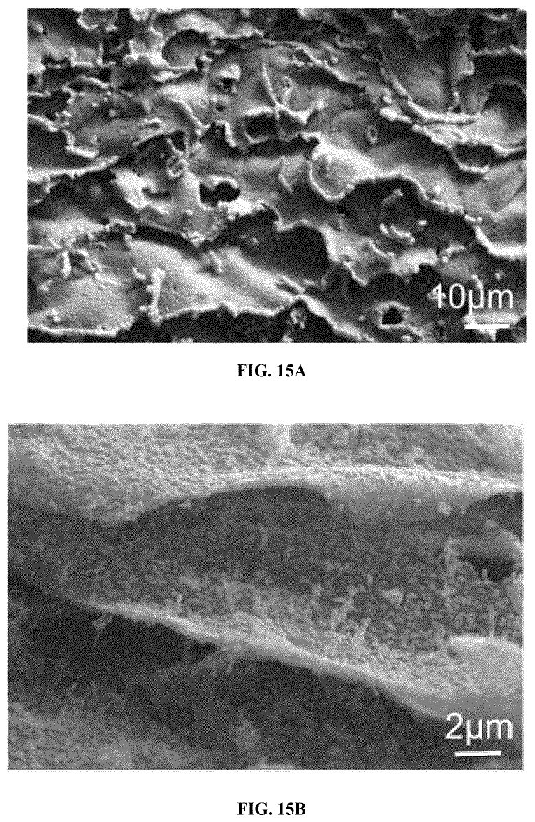

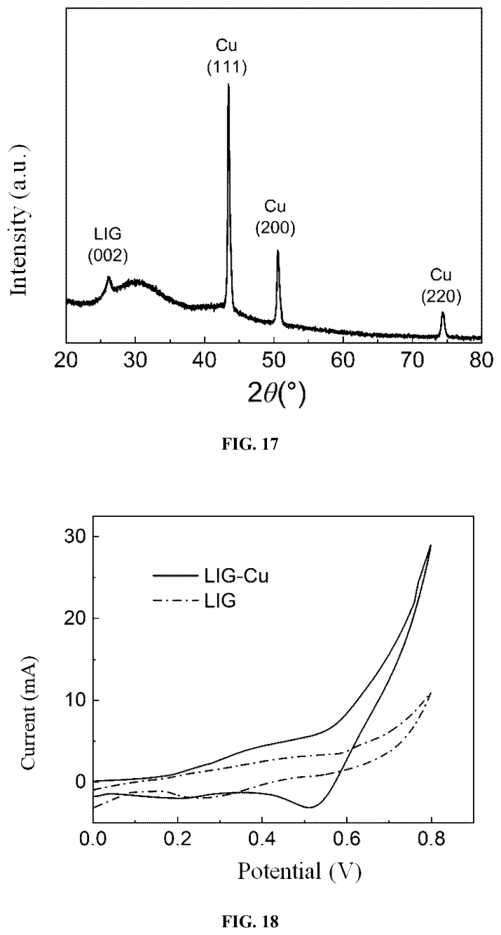

1) In the control software of a laser engraving system (U.S.A Universal, VLS3.50), a scanning area was set as a rectangle (1.5×1 cm), a laser power was set as 7.5 W, a scanning speed was set as 19 cm/s, and a Z-axis distance was set as 3 mm. Based on the above conditions, the benzoxazine monomer product was subjected to laser treatment to obtain a three-dimensional porous graphene structure (marked as LIG). The SEM images of the prepared LIG are as shown in FIG. 12A-FIG. 12B, and the Raman spectrogram is as shown in FIG. 13.
2) An electroplating solution was prepared, wherein a mixed solution of acetonitrile and water, and a volume ratio of acetonitrile to water was 3:2. After acetonitrile and water were evenly mixed, copper acetate monohydrate was added in a concentration of 0.15 g/100 mL. The solution was subjected to ultrasonic treatment until copper acetate monohydrate was completely dissolved. The solution was subjected to standing for 72 h at a room temperature, a small amount of precipitates appeared at the bottom of the solution, and supernatant was taken as a final electroplating solution. Where, the conductivity maps of different volume ratios of acetonitrile to water in the electroplating solution are shown in FIG. 14.
3) The used electroplating device is as shown in FIG. 11. LIG was a working electrode (1.5×1 cm), a Cu piece (5×5 cm) was a counter electrode, and an Ag/AgCl electrode was a reference electrode. A distance between the working electrode and the counter electrode was 5 cm, electroplating was carried out at a room temperature, and the area of the Cu piece was 5 times that of the LIG area.
4) Before electroplating, the working electrode was soaked in the electroplating solution for 30 min so that the electroplating solution sufficiently infiltrated the electrode, and then electrified for electro-deposition, with a current density of 1 mA/cm² and deposition time of 2 h. After the electroplating was completed, an LIG electrode was respectively and sufficiently rinsed with acetonitrile and water, and then dried for 1 h in a vacuum oven at 60° C. to obtain a three-dimensional graphene/metal composite material, wherein the SEM image of the three-dimensional graphene/metal composite material is as shown in FIG. 15A-FIG. 15B, and the XRD image is as shown in FIG. 17.

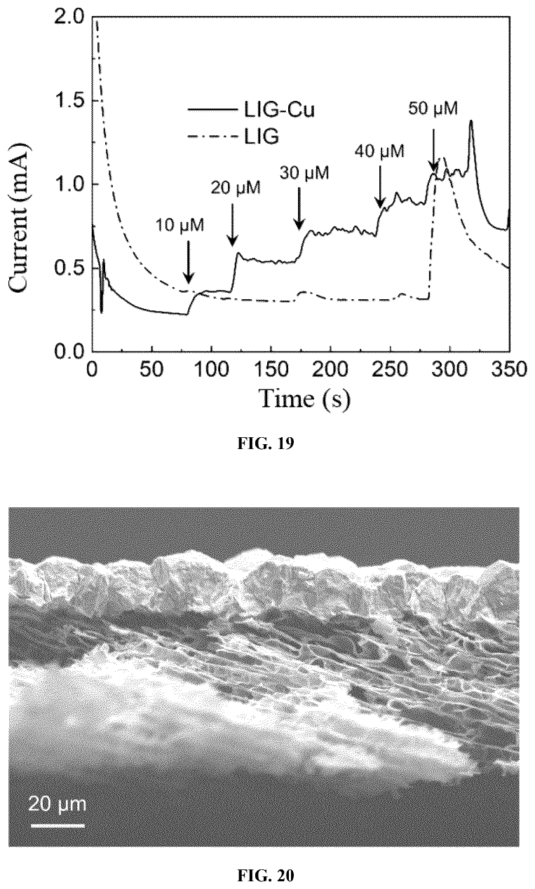

Electrochemical catalytic performance testing was performed on the three-dimensional graphene/metal composite material prepared in this example, and the CV graph when in catalytic oxidation of glucose is shown in FIG. 18; the variation of electrochemical current with time when in catalytic oxidation of glucose is shown in FIG. 19. In a 0.1M KOH solution, the sensitivity of glucose detection was 11900 μA/(mM·cm²), and the lowest detection limit was 0.79 μM.

### Example 14

### Preparation of Benzoxazine Compound

1.0 mol of pyrocatechol, 2.0 mol of aniline and 5.0 mol of paraformaldehyde reacted for 5 h at 80° C. based on dioxane as a solvent to obtain a yellow transparent solution. A saturated sodium carbonate solution and water were successively used to remove unreacted raw materials. Finally, the solvent was removed by using a rotary evaporator to obtain a benzoxazine monomer product.

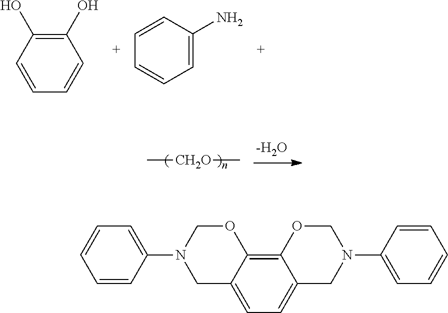

### Preparation of Three-Dimensional Graphene/Cu Composite Material:

1) A scanning area was set as a rectangle (1.5×1 cm), a laser power was set as 7.5 W, a scanning speed was set as 19 cm/s, and a Z-axis distance was set as 3 mm. Based on the above conditions, the benzoxazine monomer product was subjected to laser treatment to obtain a three-dimensional porous graphene structure (marked as LIG).
2) An electroplating solution adopted a mixed solution of ethanol and water, and a volume ratio of ethanol to water was 3:2. After ethanol and water were evenly mixed, copper acetate monohydrate was added in a concentration of 0.15 g/100 mL. The solution was subjected to ultrasonic treatment until copper acetate monohydrate was completely dissolved. The solution was subjected to standing for 72 h at a room temperature, a small amount of precipitates appeared at the bottom of the solution, and supernatant was taken as a final electroplating solution.
3) The used electroplating device is as shown in FIG. 11. LIG was a working electrode (1.5×1 cm), a Cu piece (5×5 cm) was a counter electrode, and an Ag/AgCl electrode was a reference electrode. A distance between the working electrode and the counter electrode was 5 cm, electroplating was carried out at room temperature, and the area of the Cu piece was 10 times that of the LIG area.
4) Before electroplating, the working electrode was soaked in the electroplating solution for 30 min so that the electroplating solution sufficiently infiltrated the electrode, and then electrified for electro-deposition, with a current density of 0.33 mA/cm² and deposition time of 2 h. After the electroplating was completed, an LIG electrode was respectively and sufficiently rinsed with acetonitrile and water, and then dried for 1 h in a vacuum oven at 60° C. to obtain a three-dimensional graphene/Cu composite material. In a 0.1M KOH solution, the detection sensitivity of glucose was 2096 μA/(mM·cm²), and the minimum detection limit was 0.86 μM.

### Example 15

### Preparation of Benzoxazine Compound

1.0 mol of pyrogallol, 2.0 mol of aniline and 5.0 mol of paraformaldehyde reacted for 5 h at 70° C. based on dioxane as a solvent and cooled to room temperature to separate out a large amount of white powders. The white powders were washed with hot ethanol, filtered and dried, so as to finally obtain a faint yellow powder product.

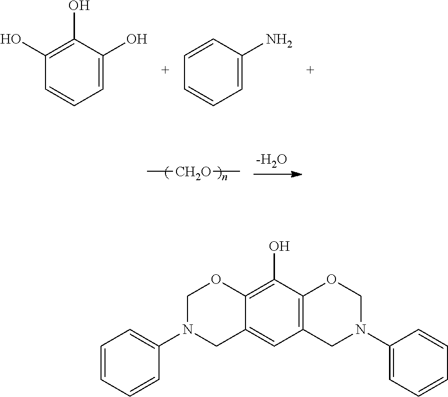

1.0 mol of faint yellow powder product was dissolved into chloroform, and then 1.2 mol of tritheylamine was added as an acid binding agent. 1.2 mol of nonanoyl chloride was slowly dropwise added into the above solution and the above solution reacted for 6 h in an ice water bath; the above solution after the reaction was completed was washed with 1.0 mol of hydrochloric acid aqueous solution and deionized water respectively. Finally, the solvent was removed by using a rotary evaporator to obtain a yellow transparent nonanoyl chloride modified benzoxazine monomer, i.e., a benzoxazine compound.

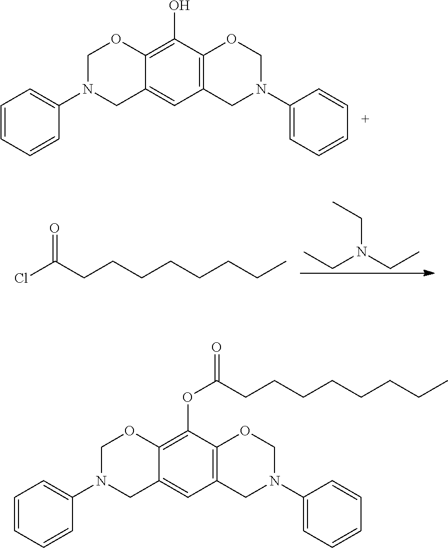

### Preparation of Three-Dimensional Graphene/Cu Composite Material:

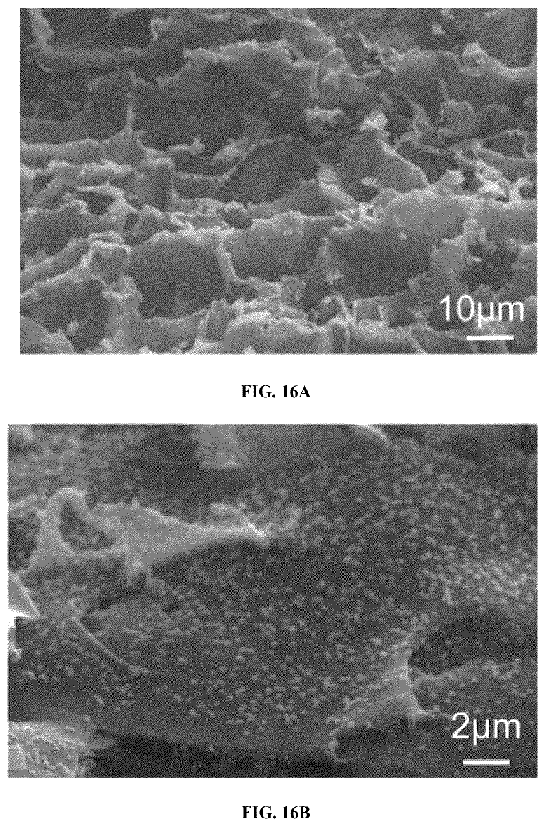

1) A scanning area was set as a rectangle (1.5×1 cm), a laser power was set as 7.5 W, a scanning speed was set as 19 cm/s, a Z-axis distance was set as 3 mm. Based on the above conditions, the benzoxazine compound was subjected to laser treatment to obtain a three-dimensional porous graphene structure (marked as LIG).
2) An electroplating solution adopted a mixed solution of ethanol and water, and a volume ratio of ethanol to water was 3:2. After ethanol and water were evenly mixed, copper acetate monohydrate was added in a concentration of 0.15 g/100 mL. The solution was subjected to ultrasonic treatment until copper acetate monohydrate was completely dissolved. The solution was subjected to standing for 72 h at room temperature, a small amount of precipitates appeared at the bottom of the solution, and supernatant was taken as a final electroplating solution.
3) The used electroplating device is as shown in FIG. 11. LIG was a working electrode (1.5×1 cm), a Cu piece (5×5 cm) was a counter electrode, and an Ag/AgCl electrode was a reference electrode. A distance between the working electrode and the counter electrode was 5 cm, electroplating was carried out at a room temperature, and the area of the Cu piece was 10 times that of the LIG area.
4) Before electroplating, the working electrode was soaked in the electroplating solution for 30 min so that the electroplating solution sufficiently infiltrated the electrode, and then electrified for electro-deposition, with a current density of 0.67 mA/cm² and deposition time of 2 h. After the electroplating was completed, an LIG electrode was respectively and sufficiently rinsed with acetonitrile and water, and then dried for 1 h in a vacuum oven at 60° C. to obtain a three-dimensional graphene/metal composite material, wherein the SEM images of the three-dimensional graphene/metal composite material are as shown in FIG. 16A-FIG. 16B. In a 0.1M KOH solution, the detection sensitivity of glucose was 4261 μA/(mM·cm²), and the minimum detection limit was 0.91 μM.

### Comparative Example 4

In comparative example 4, copper was electroplated on the surface of LIG by using a common CuSO₄ aqueous solution, wherein the concentration of CuSO₄ was 0.16 M, the concentration of H₂SO₄ was 0.1 M, the current density was 10 mA/cm², and the electroplating time was 2 h. The rest experiment methods and conditions in comparative example were the same as those in example 13.

Electroplating was performed in the CuSO₄ aqueous solution. Since the conductivity of the electroplating solution was extremely good, the deposition speed was every quick, and the electroplating layer was dense. However, due to large metal particles on the coating and limited infiltration of the aqueous solution on LIG, a uniform metal layer was finally covered onto the surface of LIG, so that the pore structure of LIG was blocked, and the interior structure cannot be sufficiently utilized. The SEM is as shown in FIG. 20. Since copper is block-shaped and isolates the contact between the solution and internal LIG, so it basically has no catalytic function. In a 0.1M KOH solution, the detection sensitivity of glucose was 25.3 μA/(mM·cm²), and the minimum detection limit was 12.6 μM.

### Comparative Example 5

In comparative example 5, copper was electroplated on the surface of LIG by using a common Cu(CH₃COO)₂ aqueous solution, wherein the concentration of Cu(CH₃COO)₂ was 0.15 g/100 mL, the current density was 1 mA/cm², and the electroplating time was 2 h. The rest experiment methods and conditions in comparative example were the same as those in example 13.

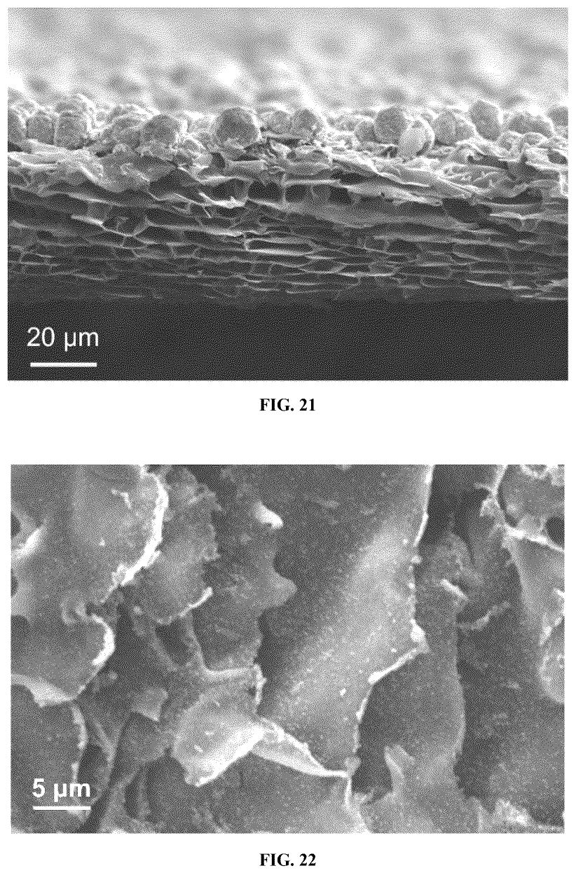

Electroplating was performed in the Cu(CH₃COO)₂ aqueous solution. The electroplating solution had good conductivity and quick deposition speed, however, due to large metal particles on the coating and limited infiltration of the aqueous solution on LIG, a uniform metal layer was finally covered onto the surface of LIG, so that the pore structure of LIG was blocked, and the interior structure cannot be sufficiently utilized. The SEM is as shown in FIG. 21. In a 0.1M KOH solution, the detection sensitivity of glucose was 253 μA/(mM·cm²), and the minimum detection limit was 5.7 μM.

### Comparative Example 6

The method was the same as that in example 13 except that water in the electroplating solution was replaced with acetonitrile. That is to say, electroplating was performed in a pure acetonitrile solution. The concentration of copper acetate was 0.15 g/100 mL, and the current density was 1 mA/cm². The microscopic morphology of the material after electroplating for 2 h is as shown in FIG. 22. Since the conductivity of the solution was low and the deposition rate of copper was low, only a small amount of copper particles after electroplating for 2 h were deposited on the surface of LIG. In a 0.1M KOH solution, the detection sensitivity of glucose was 472 μA/(mM·cm²), and the minimum detection limit was 3.6 μM. In order to further enlarge the deposition amount of large copper particles, the electroplating time (more than 10 h) needed to be prolonged.

### Comparative Example 7

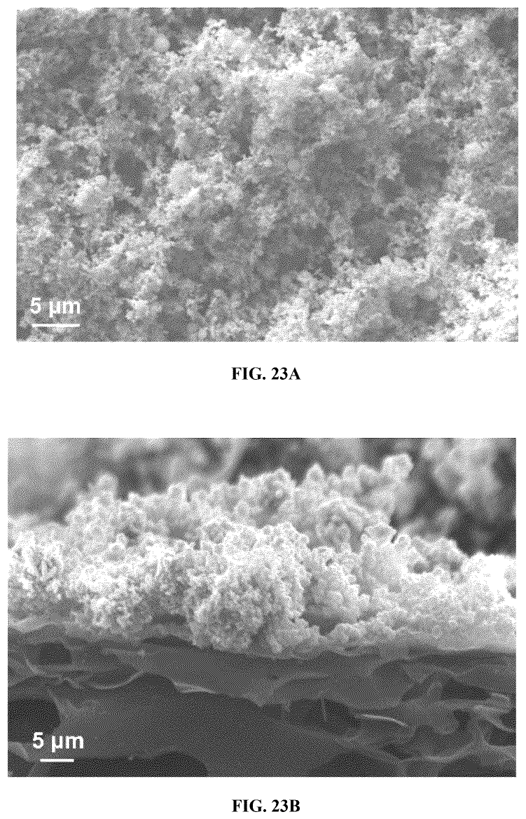

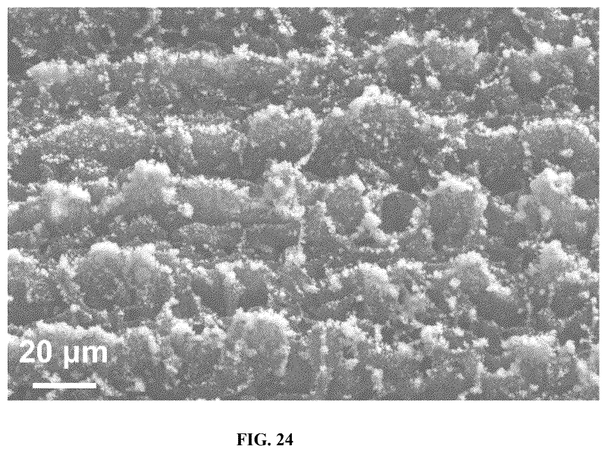

The method was the same as that in example 13 except that the volume ratio of acetonitrile to water in the electroplating solution was 1:10. The concentration of the copper acetate solution was 0.15 g/100 mL, and the current density was 1 mA/cm². The microscopic morphology of the material after electroplating for 2 h is as shown in FIG. 23A-FIG. 23B. Since the volume of water in the solution was large, the conductivity of the solution was large (about 450 μS/cm) and the deposition rate of copper in electroplating was very quick, only a large amount of copper after electroplating for 2 h were deposited on the surface of LIG, and there were almost no copper particles inside LIG. In a 0.1M KOH solution, the detection sensitivity of glucose was 57 μA/(mM·cm²), and the minimum detection limit was 9.4 μM.

### Comparative Example 8

The method was the same as that in example 13 except that the concentration of copper acetate in the electroplating solution was 0.05 g/100 mL. The current density was 1 mA/cm². The microscopic morphology of the material after electroplating for 2 h is as shown in FIG. 24. Since the volume of copper acetate in the solution was low, the deposition rate of copper was very low, only a small amount of copper particles after electroplating for 2 h were deposited on the surface of LIG (as shown in FIG. 24), and copper particles on the surface of copper were loose. In a 0.1M KOH solution, the detection sensitivity of glucose was 159 μA/(mM·cm²), and the minimum detection limit was 5.4 μM.

### Comparative Example 9

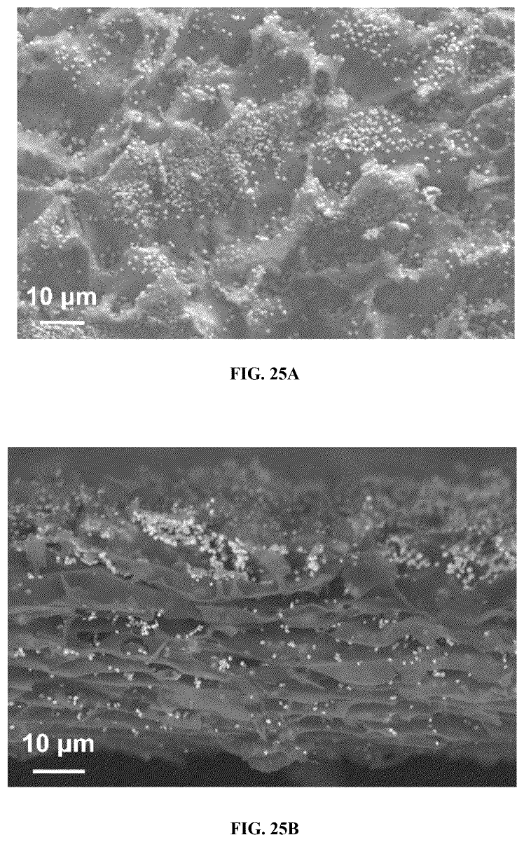

The method was the same as that in example 13 except that the concentration of copper acetate in the electroplating solution was 1.5 g/100 mL. The current density was 1 mA/cm². The microscopic morphology of the material after electroplating for 2 h is as shown in FIG. 25A-FIG. 25B. A layer of copper particles after electroplating for 2 h was deposited on the surface of LIG (as shown FIG. 25A-FIG. 25B), the diameter of the particle was 0.5-1 μm, and the sectional view shows that there were a small amount of Cu particles inside LIG. In a 0.1M KOH solution, the detection sensitivity of glucose was 6457 μA/(mM·cm²), and the minimum detection limit was 2.4 μM.

### Comparative Example 10

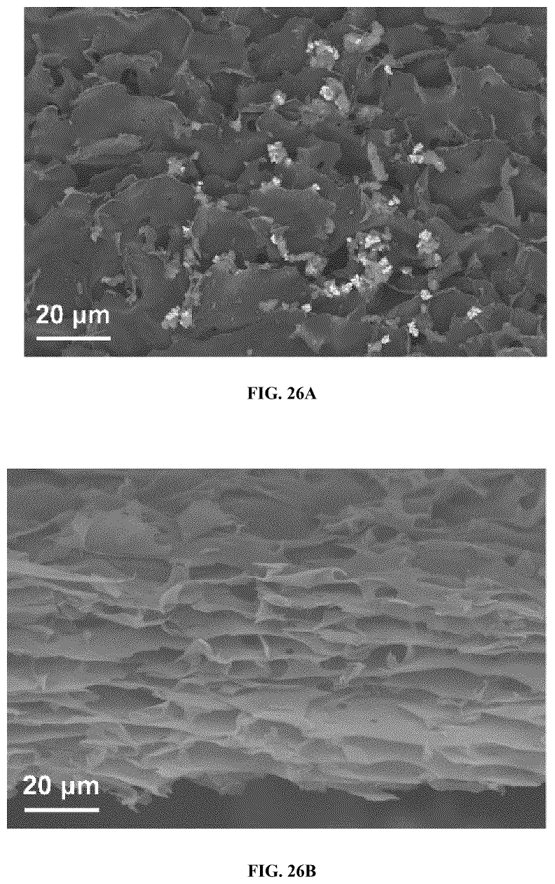

The method was the same as that in example 13 except that the current density was 0.05 mA/cm². The concentration of the electroplating solution was 0.15 g/100 mL. The microscopic morphology of the material after electroplating for 2 h is as shown in FIG. 26A-FIG. 26B. Since the concentration of copper acetate in the solution was low, the deposition rate of copper was low, only a small amount of copper particles after electroplating for 2 h were deposited on the surface of LIG with uneven particle distribution (as shown FIG. 26A-FIG. 26B). The sectional view shows that there are no copper particles inside LIG pores. In a 0.1M KOH solution, the detection sensitivity of glucose was 59 μA/(mM·cm²), and the minimum detection limit was 15.6 μM.

### Comparative Example 11

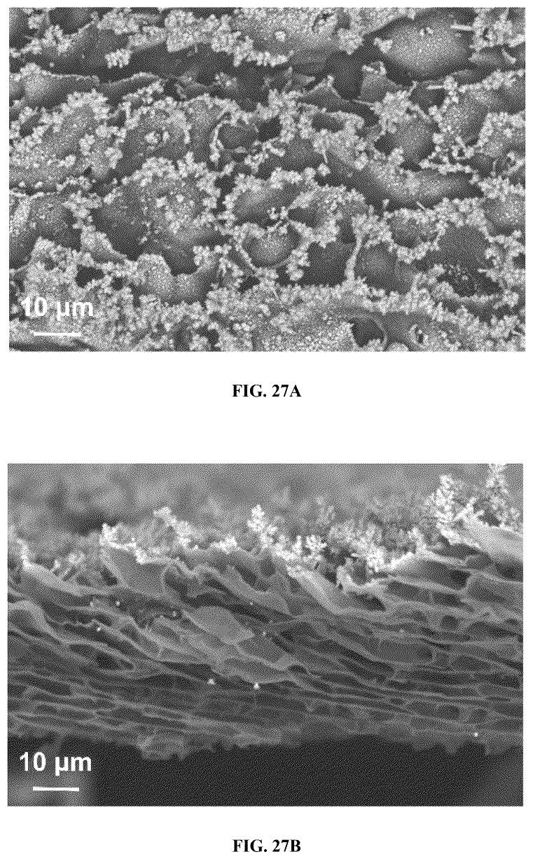

The method was the same as that in example 13 except that the current density was 5 mA/cm². The concentration of the electroplating solution was 0.15 g/100 mL. The microscopic morphology of the material after electroplating for 2 h is as shown in FIG. 27A-FIG. 27B. Since the deposition current density was large, the deposition rate of copper was low, a large amount of copper particles after electroplating for 2 h were deposited on the surface of LIG with uneven particle distribution (as shown FIG. 27A-FIG. 27B). The sectional view shows that there are no copper particles inside LIG pores. In addition, the copper particles deposited under the current density are in a loosen and porous tree-shaped structure, which may be because a hydrogen evolution reaction appears at a negative electrode under the large current density so as to generate a large amount of hydrogen. In a 0.1M KOH solution, the detection sensitivity of glucose was 568 μA/(mM·cm²), and the minimum detection limit was 4.1 μM.

### Example 16

1) In the control software of a laser engraving system (U.S.A Universal, VLS3.50), a scanning area was set as a rectangle (1.5×1 cm), a laser power was set as 2.5 W, a scanning speed was set as 6 cm/s, and a Z-axis distance was set as 0 mm. Based on the above conditions, the benzoxazine compound (benzoxazine compound in example 13) was subjected to laser treatment to obtain a three-dimensional porous graphene structure (marked as LIG).
2) An electroplating solution was prepared, wherein a mixed solution of acetone and water was used, and a volume ratio of acetone to water was 10:1. After acetone and water were evenly mixed, nickel acetate was added in a concentration of 0.05 g/100 mL. The solution was subjected to ultrasonic treatment until nickel acetate was completely dissolved.
3) The used electroplating device is as shown in FIG. 11. LIG was used as a working electrode (1.5×1 cm), a graphite electrode (5×5 cm) was a counter electrode, and an Ag/AgCl electrode was used as a reference electrode. A distance between the working electrode and the counter electrode was 5 cm, electroplating was carried out at room temperature, and the area of the Cu piece was 5 times that of the LIG area.
4) Before electroplating, the working electrode was soaked in the electroplating solution for 30 min so that the electroplating solution sufficiently infiltrated the electrode, and then electrified for electro-deposition, with a current density of 1 mA/cm² and deposition time of 2 h. After the electroplating was completed, the LIG electrode was respectively and sufficiently rinsed with acetonitrile and water, and dried for 1 h in a vacuum oven at 60° C. to obtain a three-dimensional graphene/metal composite material.

### Example 17

1) In the control software of a laser engraving system (U.S.A Universal, VLS3.50), a scanning area was set as a rectangle (1.5×1 cm), a laser power was set as 15 W, a scanning speed was set as 40 cm/s, and a Z-axis distance was set as 7 mm. Based on the above conditions, the benzoxazine compound (benzoxazine compound in example 13) was subjected to laser treatment to obtain a three-dimensional porous graphene structure (marked as LIG).
2) An electroplating solution was prepared, wherein a mixed solution of acetonitrile and water was used, and a volume ratio of acetonitrile to water was 1:4. After acetonitrile and water were evenly mixed, iron acetate was added in a concentration of 1 g/100 mL. The solution was subjected to ultrasonic treatment until iron acetate was completely dissolved.
3) The used electroplating device is as shown in FIG. 11. LIG was a working electrode (1.5×1 cm), a Cu piece (5×5 cm) was a counter electrode, and an Ag/AgCl electrode was a reference electrode. A distance between the working electrode and the counter electrode was 5 cm, electroplating was carried out at room temperature, and the area of the Cu piece was 5 times that of the LIG area.
4) Before electroplating, the working electrode was soaked in the electroplating solution for 30 min so that the electroplating solution sufficiently infiltrated the electrode, and then electrified for electro-deposition, with a current density of 1 mA/cm² and deposition time of 2 h. After the electroplating was completed, the LIG electrode was respectively and sufficiently rinsed with acetonitrile and water, and dried for 1 h in a vacuum oven at 60° C. to obtain a three-dimensional graphene/metal composite material.

In addition, the inventor of this case conducted tests by reference to aforementioned embodiments based on other raw materials, process operations and process conditions described in the specification to obtain ideal results.

It should be understood that the technical solution of the present disclosure is not limited to the above specific embodiments. Any technical deformations made according to the technical solution of the present disclosure without departing from the spirit of the present disclosure and the scope claimed in claims are all included within the scope of protection of the present disclosure.

What is claimed is:

1. A preparation method of a benzoxazine compound-based graphene material, comprising: performing an irradiation treatment on a benzoxazine compound using a laser so that the benzoxazine compound is converted into the benzoxazine compound-based graphene material;
wherein the benzoxazine compound comprises a benzoxazine monomer and/or a benzoxazine monomer derivative; the benzoxazine compound is a liquid material.

2. The preparation method according to claim 1, wherein a wavelength of the laser is 10.6 μm-248 nm;
and/or, the benzoxazine compound-based graphene material comprises a plurality of layers of graphene; wherein a layer number of the benzoxazine compound-based graphene material is 2-9 layers.

3. The preparation method according to claim 1, further comprising: reacting a mixed reaction system comprising a phenol source, an amine source, and paraformaldehyde and/or formaldehyde for 4-8 h at 70-120° C. to prepare the benzoxazine monomer;
wherein the phenol source has a structure represented by formula (I): 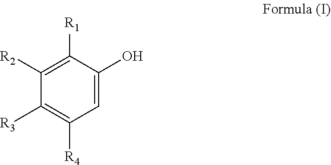
wherein R₁, R₂, R₃ and R₄ are all independently selected from a hydrogen atom, hydroxyl, carboxyl, nitro, halogen, substituted or unsubstituted alkyl, alkylene, an ester group, alkoxy, phenyl, and naphthyl;
wherein the amine source has a structure represented by formula (II):
H₂N—R₅ Formula (II)
wherein R₅ is selected from substituted or unsubstituted phenyl, furfuryl, or naphthyl; and
wherein a functional group molar ratio of the phenol source to the amine source to the paraformaldehyde and/or the formaldehyde is 1:(0.5-2):(1-5).

4. The preparation method according to claim 1, further comprising: reacting alkyl halide, alcohol, or haloalkane with the benzoxazine monomer to prepare the benzoxazine monomer derivative;
wherein the alkyl halide has a structure represented by formula (III): 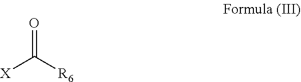
wherein X is selected from chlorine, bromine, or iodine, and R₆ is selected from substituted or unsubstituted alkyl, alkoxy, phenyl, or naphthyl;
wherein the alcohol or the haloalkane has a structure represented by formula (IV):
X—R₇ Formula (IV)
wherein X is selected from hydroxyl, chlorine, bromine, or iodine, and R₇ is selected from unsubstituted alkyl, alkoxy, phenyl, or naphthyl.

5. A benzoxazine compound-based graphene material prepared by the preparation method according to claim 1.

6. A preparation method of a benzoxazine compound-based graphene hybrid material and/or a benzoxazine compound-based graphene composite material, comprising:
mixing a benzoxazine compound with a doping precursor to form a composition, then performing an irradiation treatment on the composition using a laser to prepare the benzoxazine compound-based graphene hybrid material and/or the benzoxazine compound-based graphene composite material, wherein the benzoxazine compound comprises a benzoxazine monomer and/or a benzoxazine monomer derivative; the benzoxazine compound is a liquid material.

7. The preparation method according to claim 6, wherein the doping precursor comprises a liquid and/or powders of an organic matter and/or an inorganic matter; wherein the doping precursor comprises one or a combination of more than two of metal nanoparticles, metal oxide nanoparticles, metal carbide nanoparticles, metal salts, metal organic compounds, MXene, graphene and derivatives of the graphene, carbon nanotubes, carbon fibers, carbon nanofibers, zeolites, nitrides, boric acid, borate, phosphides, sulfides, and fluorides;
and/or, a wavelength of the laser is 10.6 μm-248 nm;
and/or, the benzoxazine compound-based graphene hybrid material and/or the benzoxazine compound-based graphene composite material comprises a plurality of layers of graphene.

8. A benzoxazine compound-based graphene hybrid material and/or a benzoxazine compound-based graphene composite material prepared by the preparation method according to claim 6.

9. (canceled)

10. A preparation method of a three-dimensional graphene/metal composite material, comprising:
performing a laser treatment on a benzoxazine compound to prepare three-dimensional graphene; wherein the benzoxazine compound is a liquid material;
and, electroplating using a mixed system comprising an acetate, an organic solvent, and water as an electroplating solution and the three-dimensional graphene as a working electrode at a current density of 0.1 mA/cm²-3 mA/cm² to prepare the three-dimensional graphene/metal composite material.

11. The preparation method according to claim 10, wherein the benzoxazine compound comprises a benzoxazine monomer and/or a benzoxazine monomer derivative;
and/or, a laser source used in the laser treatment comprises a CO₂ laser with a laser power of 2.5 W-15 W;
and/or, a scanning speed used in the laser treatment is 6-40 cm/s, and a Z-axis defocus distance is 0-7 mm;
and/or, the three-dimensional graphene has a porous structure, and a pore size of pores contained in the three-dimensional graphene is 5-20 μm.

12. The preparation method according to claim 10, comprising: performing a laser patterning treatment on the benzoxazine compound using a laser to prepare patterned three-dimensional graphene;
wherein patterns contained in the patterned three-dimensional graphene comprise an electrode structure having one or a combination of more than two of a line, a curve, a polygon, a circle, a torus, and a sector;
and/or, the preparation method comprises: evenly mixing the organic solvent with the water at a room temperature, then adding the acetate and ultrasonically dissolving, followed by a standing treatment, and separating to obtain a supernatant as the electroplating solution.

13. The preparation method according to claim 10, wherein the organic solvent comprises one or a combination of more than two of ethanol, acetonitrile and acetone;
and/or, the water is deionized water;
and/or, the acetate comprises one or a combination of more than two of anhydrous copper acetate, copper acetate monohydrate, nickel acetate, iron acetate, and cobalt acetate;
and/or, a volume ratio of the organic solvent to the water in the electroplating solution is 1:0.2-1:4;
and/or, a concentration of the acetate in the electroplating solution is 0.05 g/100 mL-1 g/100 mL;
and/or, the current density is 0.2 mA/cm²-2 mA/cm².

14. The preparation method according to claim 10, comprising: electroplating in the electroplating solution by using the three-dimensional graphene as the working electrode, a Cu slice or a graphite electrode as an auxiliary electrode, and an Ag/AgCl electrode as a reference electrode to prepare the three-dimensional graphene/metal composite material; wherein an area of the auxiliary electrode is more than 3 times an area of the working electrode;
and/or, the preparation method also comprising: washing and drying an obtained product after the electroplating is completed.

15. A three-dimensional graphene/metal composite material prepared by the preparation method according to claim 10, wherein the three-dimensional graphene/metal composite material comprises the three-dimensional graphene and nano-sized metal particles; and the nano-sized metal particles are loaded onto internal pores or external surfaces of the three-dimensional graphene; and
a particle size of the nano-sized metal particles is 100-500 nm; and the three-dimensional graphene/metal composite material comprises a three-dimensional graphene/cupper composite material; and a content of the nano-sized metal particles in the three-dimensional graphene/metal composite material is 10-70 wt %.

16. (canceled)

17. The benzoxazine compound-based graphene material according to claim 5, wherein in the preparation method, a wavelength of the laser is 10.6 μm-248 nm;
and/or, the benzoxazine compound-based graphene material comprises a plurality of layers of graphene; wherein a layer number of the benzoxazine compound-based graphene material is 2-9 layers.

18. The benzoxazine compound-based graphene material according to claim 5, wherein the preparation method further comprises: reacting a mixed reaction system comprising a phenol source, an amine source, and paraformaldehyde and/or formaldehyde for 4-8 h at 70-120° C. to prepare the benzoxazine monomer;
wherein the phenol source has a structure represented by formula (I): 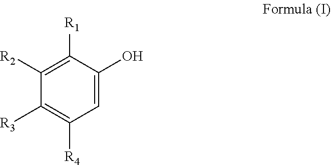
wherein R₁, R₂, R₃ and R₄ are all independently selected from a hydrogen atom, hydroxyl, carboxyl, nitro, halogen, substituted or unsubstituted alkyl, alkylene, an ester group, alkoxy, phenyl, and naphthyl;
wherein the amine source has a structure represented by formula (II):
H₂N—R₅ Formula (II)
wherein R₅ is selected from substituted or unsubstituted phenyl, furfuryl, or the naphthyl; and
wherein a functional group molar ratio of the phenol source to the amine source to the paraformaldehyde and/or the formaldehyde is 1:(0.5-2):(1-5).

19. The benzoxazine compound-based graphene material according to claim 5, wherein the preparation method further comprises: reacting alkyl halide, alcohol, or haloalkane with the benzoxazine monomer to prepare the benzoxazine monomer derivative;
wherein the alkyl halide has a structure represented by formula (III): 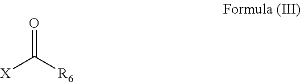
wherein X is selected from chlorine, bromine, or iodine, and R₆ is selected from substituted or unsubstituted alkyl, alkoxy, phenyl, or naphthyl;
wherein the alcohol or the haloalkane has a structure represented by formula (IV):
X—R₇ Formula (IV)
wherein X is selected from hydroxyl, chlorine, bromine, or iodine, and R₇ is selected from unsubstituted alkyl, alkoxy, phenyl, or naphthyl.

20. The benzoxazine compound-based graphene hybrid material and/or the benzoxazine compound-based graphene composite material according to claim 8, wherein in the preparation method, the doping precursor comprises a liquid and/or powders of an organic matter and/or an inorganic matter; wherein the doping precursor comprises one or a combination of more than two of metal nanoparticles, metal oxide nanoparticles, metal carbide nanoparticles, metal salts, metal organic compounds, MXene, graphene and derivatives of the graphene, carbon nanotubes, carbon fibers, carbon nanofibers, zeolites, nitrides, boric acid, borate, phosphides, sulfides, and fluorides;
and/or, a wavelength of the laser is 10.6 μm-248 nm;
and/or, the benzoxazine compound-based graphene hybrid material and/or the benzoxazine compound-based graphene composite material comprises a plurality of layers of graphene.
